(19) United States
(12) Patent Application Publication
(10) Pub. No.: US 2011/0183614 A1
(43) Pub. Date: Jul. 28, 2011

(54) COMMUNICATION TERMINAL

(75) Inventor: Toshiya TAMURA, Tokyo (JP)

(73) Assignee: KABUSHIKI KAISHA TOSHIBA, Tokyo (JP)

(21) Appl. No.: 12/853,451

(22) Filed: Aug. 10, 2010

(30) Foreign Application Priority Data
Jan. 25, 2010 (JP) P2010-013476
Jan. 25, 2010 (JP) P2010-013477
Jan. 28, 2010 (JP) P2010-016968

(51) Int. Cl. H04B 7/00

(52) U.S. Cl. 455/41.2

(57) ABSTRACT

A communication terminal includes an authentication control module configured to: determine whether or not the counterpart device for which the communication mode switching request is permitted is a registered counterpart device based on a pairing request corresponding to the communication mode switching request notified from the communication mode controller; and control the pairing controller to discard the pairing request corresponding to the communication mode switching request notified from the communication mode controller not to perform pairing including an authentication process by the second wireless communication module when determined that the counterpart device for which the communication mode switching request has been permitted is the registered counterpart device.

### CROSS-REFERENCE TO THE RELATED APPLICATION (S)

The present application is based upon and claims priority from prior three Japanese Patent Applications No. 2010-013476, filed on Jan. 25, 2010, No. 2010-013477, filed on Jan. 25, 2010, No. 2010-016968, filed on Jan. 28, 2010, the entire contents of which are incorporated herein by reference.

### BACKGROUND

1. Field

This embodiment relates to a communication terminal capable of establishing a connection by pairing with a counterpart device.

This embodiment relates to a communication terminal capable of efficiently searching for a counterpart device by using two wireless communication units.

2. Description of the Related Art

Recently, for example, Bluetooth (registered trademark) has been known as a wireless communication technology applicable to communication terminals including a mobile phone. The communication terminals including a mobile phone may transmit audio data to a counterpart device such as a headset or the like by using the wireless communication technology of Bluetooth without use of an audio cable. As the specification in the case where the communication terminals including a mobile phone perform a pairing process by using the wireless communication technology of Bluetooth, Bluetooth specification version 2.1+EDR prescribed in the Bluetooth SIG has been known.

On the other hand, the connection handover technical specification prescribed in the NFC (Near Field Communication) forum has been known as the specification related to negotiation for deciding another wireless communication mode to which the communication terminals including a mobile phone perform a handover by NFC (switch the communication mode). NFC is the international standard for the technology of short-distance wireless communication which is performed at a distance of about 10 to 30 cm.

A communication terminal based on two specifications of the Bluetooth specification version 2.1+EDR and the connection handover technical specification has at least a communication unit applicable to the wireless communication mode of Bluetooth and a communication unit applicable to the wireless communication mode of NFC, and may perform the handover between the two different communication modes (switch the communication mode).

In the Bluetooth specification version 2.1+EDR, a pairing type called Secure Simple Pairing (SSP) prescribed. As one of SSP pairing types, an Out Of Band (OOB) pairing type is prescribed.

In the case of the OOB pairing type, a mechanism is set in which the communication terminal acquires necessary device information and security information of a counterpart device from the counterpart device by using a communication mode (a wireless communication mode of NFC or the like) other than Bluetooth at the time of pairing with the counterpart device which performs short-distance wireless communication by using Bluetooth.

The communication terminal based on the two specifications of the Bluetooth specification version 2.1+EDR and the connection handover technical specification performs the handover to Bluetooth which is a communication mode different from the communication mode of NFC based on negotiation for performing the handover using NFC (switching the communication mode).

At this time, users may cause two communication terminals to internally do the negotiation for the handover using NFC by holding the two communication terminals at a short distance to an extent to which mutual NFC communication is possible or by overlapping the two communication terminals with each other, and may start a pairing process by Bluetooth. The operation of holding (touching) the two communication terminals close to each other is a notably reasonable method as a method intended for a pairing request in consideration of usability.

However, the above-described operation of holding (touching) the two communication terminals close to each other is interpreted as the intention for the start of an overall connection process based on a connection request by Bluetooth rather than the intention only for the pairing process by Bluetooth. Thus, the communication terminal may also transmit a re-pairing request to another communication terminal which has already been completely paired.

When a re-pairing process is executed by the communication terminal, there is a problem in that a name (nickname) of a counterpart device (another communication terminal) resolutely changed by the user using the communication terminal returns to an inorganic device name originally possessed by the counterpart device. However, a practical operation for solving the above-described problem is not prescribed even in any of the two specifications of the Bluetooth specification version 2.1+EDR and the connection handover technical specification.

The communication terminal based on the two specifications of the Bluetooth specification version 2.1+EDR and the connection handover technical specification performs the handover to Bluetooth which is a communication mode different from the communication mode of NFC based on negotiation for performing the handover using NFC (switching the communication mode).

However, when the communication terminal receives a connection request from a counterpart device, the communication terminal may not finally establish a connection with the counterpart device by using Bluetooth as long as Bluetooth is not available at the handover time even though the handover has been made from the NFC communication mode to the Bluetooth communication mode.

Specifically, it is assumed that the communication terminal stops a Bluetooth communication module as much as possible from the viewpoint of power saving even though the communication terminal receives the connection request from the counterpart device. Under this situation, it is not always necessarily the case that Bluetooth is constantly available at the handover time. For example, even though the communication terminal has performed the handover from the NFC communication mode to the Bluetooth communication mode, the communication terminal may not finally establish the connection with the counterpart device by using Bluetooth.

In this case, there is a problem in that the counterpart device, which has succeeded in negotiation related to the handover from the NFC communication mode to the Bluetooth communication mode, continues repeatedly to transmit a connection request to the communication terminal until the connection using Bluetooth is established between the counterpart device and the communication terminal. However, a practical operation for solving the above-described problem is not prescribed even in any of the two specifications of the Bluetooth specification version 2.1+EDR and the connection handover technical specification.

There is a problem in that the communication terminal may receive a connection request from a second counterpart device different from a first counterpart device with which the communication terminal has negotiated in relation to the handover by using NFC until secure simple pairing (SSP) by Bluetooth is started by the handover from the NFC communication mode to the Bluetooth communication mode after the communication terminal performs the negotiation related to the handover with the first counterpart device by using NBC.

In this case, there is a problem in that the communication terminal may not accept an SSP request (authentication request) based on the connection request from the first counterpart device regardless of the fact that the communication terminal has received the connection request from the first counterpart device after receiving a connection request from the second counterpart device, in spite of the fact that the handover directed to Bluetooth has been permitted for the first counterpart device. However, a practical operation for solving the above-described problem is not prescribed even in any of the two specifications of the Bluetooth specification version 2.1+EDR and the connection handover technical specification.

The communication terminal based on the two specifications of the Bluetooth specification version 2.1+EDR and the connection handover technical specification performs the handover by Bluetooth which is a communication mode different from the communication mode of NFC based on negotiation using NFC (switches the communication mode).

At this time, users may cause two communication terminals to internally do the negotiation for the handover using NFC by holding the two communication terminals at a short distance to an extent to which mutual NFC communication is possible or by overlapping the two communication terminals with each other, and may start a pairing process by Bluetooth.

The operation of holding (touching) the two communication terminals close to each other is a significantly reasonable method as a method intended for a pairing request in consideration of usability. An operation is possible to replace the operation of holding (touching) the two communication terminals close to each other by an operation of the related art which attempts to establish a connection to a selected device after a user selects the device from a list of search results by pre-searching for counterpart devices located around the communication terminal.

However, all communication terminals do not necessarily have a communication unit applicable to the wireless communication mode of NFC as well as a communication unit applicable to the wireless communication mode of Bluetooth. When a counterpart device with which the communication terminal establishes a connection by using Bluetooth communication does not have the communication unit applicable to the wireless communication mode of NFC, the communication terminal may not perform communication using the wireless communication mode of NFC, for example, even though the communication terminal starts negotiation with the counterpart device for the handover using NFC.

Thus, in this case, it is necessary for the communication terminal to search for the counterpart device according to the operation of the related art. When a connection with the counterpart device is established using Bluetooth communication, the communication terminal first checks whether or not the communication unit applicable to the wireless communication mode of NFC is mounted after the two communication terminals are held at a short distance to an extent to which mutual NFC communication is possible, and searches for the counterpart device according to the operation of the related art after the check when the communication unit applicable to the wireless communication mode of NFC is not mounted.

In the case where the counterpart device is not provided with the communication unit applicable to the wireless communication mode of NFC, there is a problem in that a significant period of time is taken until the communication terminal acquires device information or the like regarding the counterpart device. However, a practical operation for solving the above-described problem is not prescribed even in any of the two specifications of the Bluetooth specification version 2.1+EDR and the connection handover technical specification.

### BRIEF DESCRIPTION OF THE DRAWINGS

A general configuration that implements the various features of the present invention will be described with reference to the drawings. The drawings and the associated descriptions are provided to illustrate embodiments of the invention and not to limit the scope of the invention.

FIG. 1 is a block diagram showing an internal configuration of a mobile phone applicable to a communication terminal according to a first embodiment.

FIGS. 2A to 2C are diagrams showing examples of communication using NFC communication modules between a mobile phone 1-1 and a mobile phone 1-2 according to the first embodiment in the case of an Out Of Band (OOB) pairing type.

FIG. 3 is a flowchart illustrating a pairing control process in the mobile phone 1-1 shown in FIG. 1 when the mobile phone 1-1 and the mobile phone 1-2 are paired using a Bluetooth communication module.

FIG. 4 is a sequence diagram showing a specific process between the mobile phone 1-1 (its own device) and the mobile phone 1-2 (counterpart device) when the pairing control process illustrated by using the flowchart of FIG. 3 is executed.

FIG. 5 is a table showing a counterpart-device information table in which information regarding the counterpart device already paired with the mobile phone 1-1 by using a Bluetooth communication module 25 is associated.

FIG. 6 is a block diagram showing the internal configuration of a mobile phone applicable to a communication terminal according to a second embodiment.

FIG. 7 is a flowchart illustrating a pairing control process in a mobile phone 1-1 of FIG. 6 when the mobile phone 1-1 and a mobile phone 1-2 are paired using a Bluetooth communication module.

FIG. 8 is a sequence diagram showing a specific process between the mobile phone 1-1 (its own device) and the mobile phone 1-2 (counterpart device) when the pairing control process illustrated by using the flowchart of FIG. 7 is executed.

FIG. 9 is a flowchart illustrating another pairing control process in the mobile phone 1-1 of FIG. 6 when the mobile phone 1-1 and the mobile phone 1-2 are paired using a Bluetooth communication module.

FIG. 10 is a sequence diagram showing a specific process between the mobile phone 1-1 (its own device) and the mobile phone 1-2 (counterpart device) when the pairing control process illustrated by using the flowchart of FIG. 9 is executed.

FIG. 11 is a flowchart illustrating another pairing control process in the mobile phone 1-1 of FIG. 6 when the mobile phone 1-1 and the mobile phone 1-2 are paired using the Bluetooth communication module.

FIG. 12 is a block diagram showing the internal configuration of a mobile phone applicable to a communication terminal according to a third embodiment.

FIG. 13 is a flowchart illustrating a device search process in a mobile phone 1-1 of FIG. 12 when the mobile phone and a mobile phone 1-2 are paired using a Bluetooth communication module.

FIG. 14 is a sequence diagram showing a specific process between the mobile phone 1-1 (its own device) and the mobile phone 1-2 (counterpart device) when the device search process illustrated by using the flowchart of FIG. 13 is executed.

FIGS. 15A to 15C are diagrams showing display examples of a counterpart-device registration menu screen displayed on a display device.

FIG. 16 is a flowchart illustrating another device search process in the mobile phone 1-1 of FIG. 12 when the mobile phone 1-1 and the mobile phone 1-2 are paired using the Bluetooth communication module.

### DETAILED DESCRIPTION

Embodiments according to the present invention will be described in detail with reference to the accompanying drawings. The scope of the claimed invention should not be limited to the examples illustrated in the drawings and those described in below.

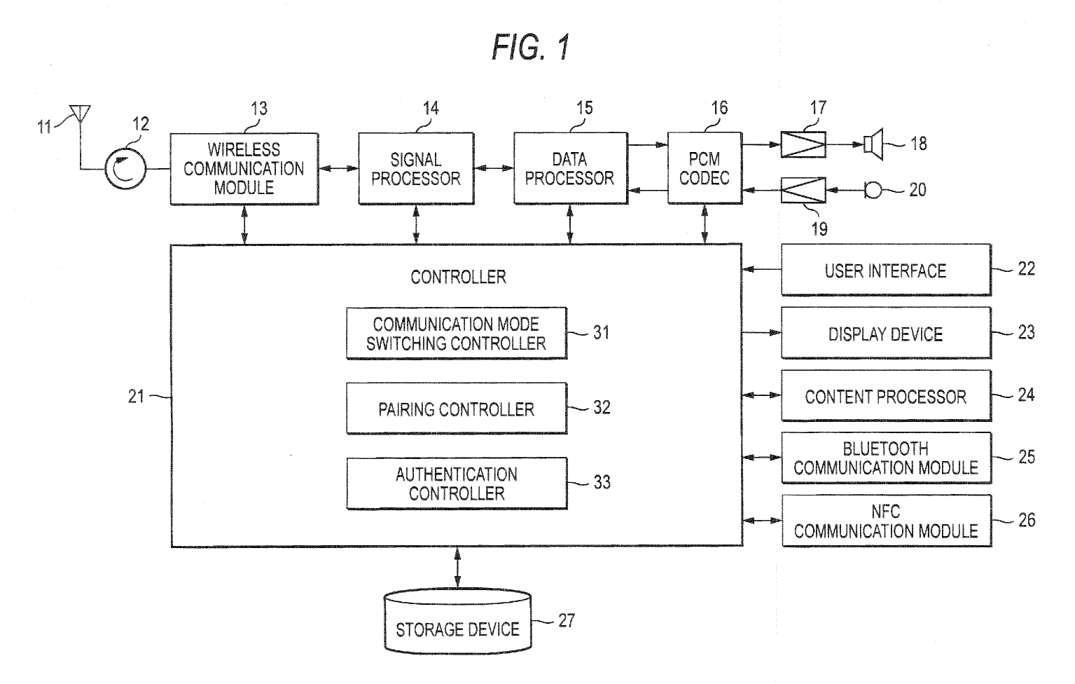

FIG. 1 shows an internal configuration of a mobile phone 1 applicable to a communication terminal according to a first embodiment. The mobile phone 1 includes an antenna 11, a sharing module 12, a wireless communication module 13, a signal processor 14, a data processor 15, a PCM codec 16, an output amplifier 17, a receiver 18, an input amplifier 19, a microphone 20, a controller 21, an user interface 22, a display device 23, a content processor 24, a Bluetooth communication module 25, an NFC communication module 26, and a storage device 27.

The antenna 11 transmits a radio wave of a mobile communication system corresponding to the mobile phone 1, and receives a radio wave of a mobile communication system corresponding to the mobile phone 1. The sharing module 12 includes a circulator, a duplexer, or the like, and sends a radio wave received by the antenna 11 to the wireless communication module 13. The sharing module 12 sends a signal input from the wireless communication module 13 to the antenna 11.

The wireless communication module 13 includes a band pass filter, a gain adjustment circuit, an A/D converter, and the like, receives a radio signal of a carrier frequency indicated from the controller 21, converts frequency of (down-converts) the radio signal into an intermediate frequency signal by mixing the radio signal with a local oscillation signal output from a frequency synthesizer, and generates a baseband signal by quadrature-demodulating the intermediate frequency signal into which the radio signal has been down-converted. The band pass filter of the wireless communication module 13 receives a radio signal transmitted from a base station belonging to the mobile communication system and removes noise out of a desired band from the received signal. The gain adjustment circuit of the wireless communication module 13 performs adjustment to a signal amplitude which is capable of being treated by the A/D converter provided in a subsequent stage of the gain adjustment circuit. The A/D converter of the wireless communication module 13 converts the signal passing through the band pass filter into a baseband digital signal.

The signal processor 14 executes a baseband process for the received baseband signal (received baseband digital signal) output from the wireless communication module 13. For example, the data processor 15 includes a DSP (Digital Signal Processor) or the like, and converts the baseband signal for which the signal processor 14 has executed the baseband process into data and audios. That is, the data processor 15 first separates received packet data for each media, and applies a decoding process for each of the data separated for each media. Specifically, for example, when audio data is included in the received packet data, the data processor 15 decodes the audio data by a speech codec.

When video data is included in the received packet data, the data processor 15 decodes the video data by a video codec. When the received packet data is download content, the data processor 15 decompresses the download content. After the digital audio signal obtained by the decoding process is PCM-decoded by the PCM codec 16, the decoded signal is amplified by the output amplifier 17 and the amplified signal is output by the receiver 18. On the other hand, the digital video signal decoded by the video codec is supplied and displayed to the display device 23 via the controller 21.

The wireless communication module 13 and the signal processor 14 execute a series of processes such as a transmission baseband process, a radio process, and the like for transmitting communication, data to the base station belonging to the mobile communication system.

The controller 21 includes CPU (Central Processing Unit), ROM (Read Only Memory), RAM (Random Access Memory), and the like. The CPU of the controller 21 executes various processes according to a program stored in the ROM, various application programs including an operating system (OS) or a control program loaded from the storage device 27 to the RAM, and also comprehensively controls the mobile wireless terminal 1 by generating various control signals and supplying the generated control signals to respective parts. The RAM appropriately stores necessary data after the CPU executes various processes. Specifically, the controller 21 has a control function of implementing voice communication or data communication by the mobile communication system.

When communication control is performed, the controller 21 controls a communication process using the antenna 11, the wireless communication module 13, the signal processor 14, the data processor 15, the PCM codec 16, the output amplifier 17, the receiver 18, the input amplifier 19, the microphone 20, and the like. On the other hand, the controller 21 controls a UI process using the user interface 22, the display device 23, the storage device 27, and a clock circuit (not shown).

For example, when a music player is controlled, the content processor 24 executes a re-encoding process or the like in another encoding scheme (for example, SBC (Sub Band Coding) or the like) after first decoding audio data, encoded in an encoding type such as AAC or MP3, in a decoding scheme corresponding to the encoding scheme.

The Bluetooth communication module 25 is one of the short-distance wireless communication units provided in the mobile phone 1, and, for example, includes a module which performs wireless communication by Bluetooth (registered trademark) or the like. The Bluetooth communication module 25 wirelessly communicates with a headset, another mobile phone 1, or the like located in the vicinity of the mobile phone 1. The Bluetooth communication module 25 may use wireless communication (for example, infrared communication) other than Bluetooth.

The NFC communication module 26 is one of the short-distance wireless communication units provided in the mobile phone 1, and includes a module applicable to NFC which is the international standard for the technology of short-distance wireless communication which is performed at a distance of about 10 to 30 cm. The NFC communication module 26 functions as anon-contact IC card, and, for example, may be used as a traffic ticket or an entering/leaving management card. When the mobile phone 1 is held close to an IC reader/writer (not shown) and receives an electromagnetic wave radiated from the IC reader/writer, the NFC communication module 26 wirelessly communicates with the IC reader/writer by using various information in response thereto.

The mobile phone 1 of FIG. 1 may perform data communication by using NFC with another mobile phone 1 having the NFC communication module 26. In the case of short-distance wireless communication using the NFC communication module 26, a security check procedure is simplified since it is necessary to hold each other's NFC communication module 26 at a close distance.

For example, the storage device 27 includes HDD (Hard Disc Drive) or a flash memory device which is an electrically rewritable or erasable non-volatile memory, and stores various application programs or various data groups to be executed by the CPU of the controller 21, or a control program or control data of the mobile phone 1.

The storage device 27 appropriately stores phone book data in which a name is associated with a phone number or data received or downloaded by data communication. The mobile phone 1 has a power supply circuit which generates a given operation power supply voltage Vcc based on an output of a battery and supplies the generated voltage to each circuit part, or a clock circuit (timer) which measures the present time.

The mobile phone 1 has the output amplifier 17, the receiver 18 which amplifies and outputs an incoming speech audio signal, the input amplifier 19, the microphone 20 which inputs an outgoing speech audio signal, the user interface 23 which receives a request from the user, and the display device 24 which displays an image based on received data.

Here, the mobile phone 1 according to the first embodiment includes two short-distance wireless communication units of the Bluetooth communication module 25 and the NFC communication module 26 as described above. When the mobile phone 1 transmits/receives a large volume of data to/from another mobile phone 1 (counterpart device) similarly having the two short-distance wireless communication units of the Bluetooth communication module 25 and the NFC communication module 26, device information (information including a device address or the like) unique to each other's mobile phone 1 is first exchanged by negotiation using each other's NFC communication module 26.

Next, the mobile phone 1 performs pairing including an authentication process by each other's Bluetooth communication module 25 using device information of another mobile phone 1 received by negotiation via the NFC communication module 26. Thereafter, the mobile phone 1 transmits/receives a large volume of data by using the Bluetooth communication module 25 with another mobile phone 1.

Here, in a first step, first, the short-distance wireless communication is performed using the NFC communication module 26 in which a security check procedure is simplified. Thereafter, in a second step, an operation of switching to (taking over) short-distance wireless communication using the Bluetooth communication module 25 in which faster data communication than NFC communication is possible is defined as a “handover”. That is, the “handover” indicates switching of a short-distance wireless communication mode.

The device information of another mobile phone 1 received by negotiation via the NFC communication module 26 is included in a handover request from another mobile phone 1 received upon negotiation via the NFC communication module 26. When the mobile phone 1 according to the first embodiment has received the handover request from another mobile phone 1, the pairing including the authentication process is performed by the Bluetooth communication module 25.

Accordingly, the handover request means a pairing request using the Bluetooth communication module 25 as well as a switching request of the short-distance wireless communication mode. In this meaning, the handover request is a request directed to pairing to be subsequently performed from an intention of the user who performs an NFC touch operation. More accurately, device-specific device information or the like is included in a request to be exchanged upon handover negotiation to be performed using the NFC communication modules 26 between two devices.

When the handover request has been received from another mobile phone 1, the mobile phone 1 according to the first embodiment basically performs the pairing including the authentication process by the Bluetooth communication module 25. However, even though the handover request has been received from another mobile phone 1, the mobile phone 1 discards a pairing request (a pairing request corresponding to the handover request) included in the handover request from the counterpart device, exceptionally when the handover request has been received from the already registered counterpart device, and does not perform the pairing including the authentication process by the Bluetooth communication module 25.

The controller 21 has a communication mode switching controller 31, a pairing controller 32, and an authentication controller 33. The communication mode switching controller (handover controller) 31 of the controller 21 controls a process of acquiring device information and security information of the counterpart device necessary at the time of pairing with the counterpart device (the mobile phone 1 or the like) which performs short-distance wireless communication using the Bluetooth communication module 25 from the counterpart device by using a communication mode (for example, the wireless communication mode of NFC or the like) other than Bluetooth.

Specifically, at the time of pairing with the counterpart device which performs the short-distance wireless communication by using the Bluetooth communication module 25, the communication mode switching controller 31 controls the NFC communication module 26, negotiates with another mobile phone 1 located in the vicinity of the mobile phone 1 by using the NFC communication module 26, receives the handover request from another mobile phone 1 upon negotiation, exchanges security information or device information (information including a device address or the like) unique to each other's mobile phone 1, decides a communication mode (for example, a communication mode by the Bluetooth communication module 25) of a switching destination from the NFC communication mode, and controls switching directed to the switching destination (handover).

The communication mode switching controller 31 notifies the authentication controller the pairing request included in the handover request (the pairing request corresponding to the handover request). That is, the communication mode switching controller 31 notifies the authentication controller 33 of the fact that the pairing with another mobile phone 1-2 for which the handover request has been permitted is started by switching the communication mode from the communication mode by the NFC communication module 26 to the communication mode by the Bluetooth communication module 25 based on the handover request.

The pairing controller 32 controls the pairing with the counterpart device (another mobile phone 1) which performs short-distance wireless communication by using the Bluetooth communication module 25. For example, the pairing is a pairing type called Secure Simple Pairing (SSP).

The authentication controller 33 determines whether or not the counterpart device (another mobile phone 1) for which the handover request has been permitted is an already registered (paired) counterpart device based on the pairing request included in the handover request notified from the communication mode switching controller 31.

In the case of determining that the counterpart device (another mobile phone 1) for which the handover request has been permitted is the already registered (paired) counterpart device, the authentication controller 33 discards the pairing request included in the handover request notified from the communication mode switching controller 31 without providing the pairing controller 32 with the pairing request included in the handover request notified from the communication mode switching controller 31, and without causing the pairing controller 32 to perform the pairing including the authentication process by the Bluetooth communication module 25.

On the other hand, in the case of determining that the counterpart device (another mobile phone 1) for which the handover request has been permitted is not an already registered (paired) counterpart device, the authentication controller 33 provides the pairing controller 32 with the pairing request included in the handover request notified from the communication mode switching controller 31 without discarding the pairing request included in the handover request notified from the communication mode switching controller 31, and causes the pairing controller 32 to perform the pairing including the authentication process by the Bluetooth communication module 25.

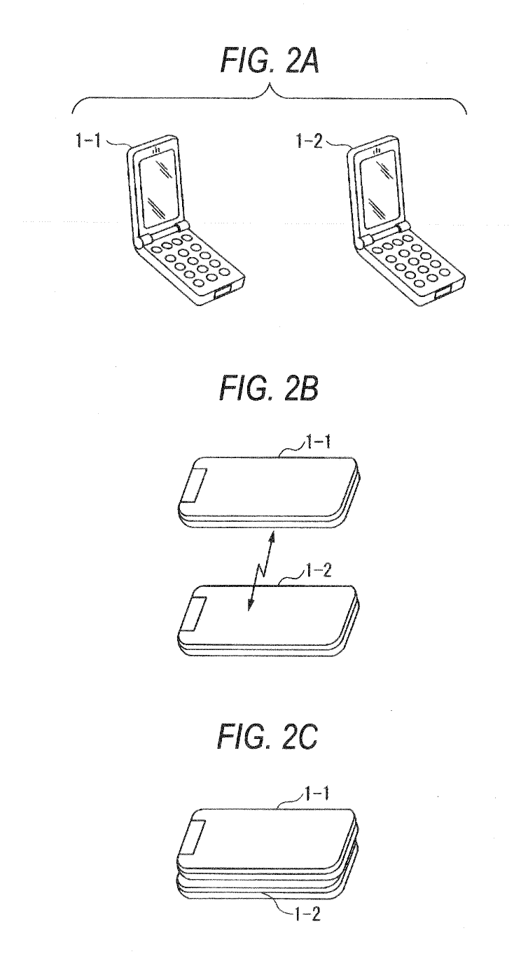

FIGS. 2A to 2C are diagrams showing the form of communication using the NFC communication modules 26 between the mobile phone 1-1 and the mobile phone 1-2 in the case of an Out Of Band (OOB) pairing type.

As shown in FIGS. 2A and 2B, when the mobile phone 1-1 in which the NFC communication module 26 is built is held close to the mobile phone 1-2, electromagnetic induction occurs within the mobile phone 1-2 by an electromagnetic wave radiated from the mobile phone 1-1, and the mobile phone 1-2 exchanges data by short-distance communication (NFC communication) with the mobile phone 1-1 by using a current generated thereby.

The mobile phone 1-1 may be held close to the mobile phone 1-2. In contrast, the mobile phone 1-2 may be held close to the mobile phone 1-1. As shown in FIG. 2C, when the NFC communication is performed between two mobile phones, the two mobile phones 1 may overlap with each other. An operation of holding the two mobile phones at a short distance to an extent to which mutual NFC communication is possible or an operation of overlapping the two mobile phones 1 with each other is defined as “NFC touch”.

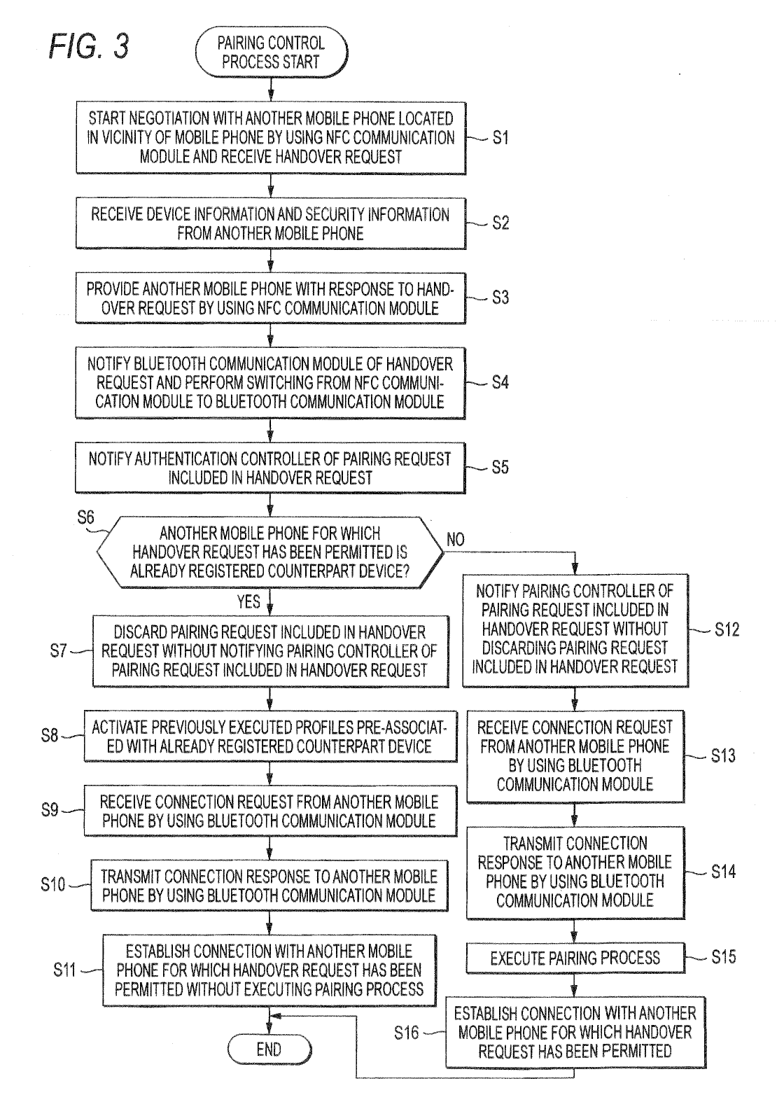

A pairing control process in the mobile phone 1-1 of FIG. 1 when the mobile phone 1-1 and the mobile phone 1-2 are paired using the Bluetooth communication module 25 will be described with reference to the flowchart of FIG. 3.

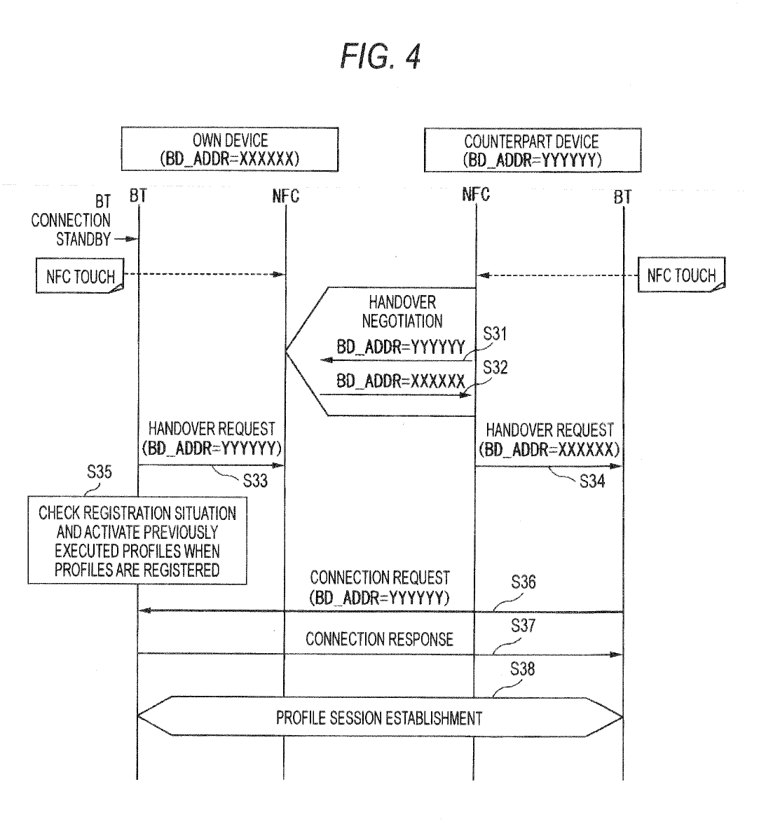

The pairing control process is executed by the mobile phone 1-1 when the NFC touch is done between the two mobile phones in the case where the mobile phone 1-1 waits for a Bluetooth communication connection. FIG. 4 shows a sequence of a specific process between the mobile phone 1-1 (its own device) and the mobile phone 1-2 (counterpart device) when the pairing control process illustrated by using the flowchart of FIG. 3 is executed.

In step S1, when the NFC touch is done between the mobile phone 1-1 and the mobile phone 1-2, the communication mode switching controller 31 of the mobile phone 1-1 starts negotiation with another mobile phone 1-2 located in the vicinity of the mobile phone 1 by using the NFC communication module 26. The NFC communication module 26 of the mobile phone 1-1 receives the handover request from another mobile phone 1-2 during negotiation with another mobile phone (step S31 of FIG. 4).

The handover request includes security information and device information (information including a device address or the like) unique to another mobile phone 1-2. The device information unique to another mobile phone 1-2 is “BD_ADDR=YYYYYY”. On the other hand, the device information unique to its own mobile phone 1-1 is “BD_ADDR=XXXXXX”.

In step S2, the communication mode switching controller 31 of the mobile phone 1-1 acquires the security information and the device information unique to another mobile phone 1-2 from the handover request received by the NFC communication module 26. The communication mode switching controller 31 of the mobile phone 1-1 provides the pairing controller 32 with the received security information and the received device information unique to another mobile phone 1-2.

In step S3, the communication mode switching controller 31 of the mobile phone 1-1 sets the communication mode of the switching destination from the NFC communication mode to the communication mode by the Bluetooth communication module 25, and transmits a response (handover response) to the handover request to another mobile phone 1-2 by using the NFC communication module 26 (step S32 of FIG. 4).

In step S4, the communication mode switching controller 31 notifies the Bluetooth communication module 25 of the handover request (the request for switching the communication mode from the communication mode by the NFC communication module 26 to the communication mode by the Bluetooth communication 25), and switches the communication mode from the NFC communication module 26 to the Bluetooth communication module 25 for the pairing using the Bluetooth communication module 25 (step S33 of FIG. 4).

At this time, when the mobile phone 1-2 as the counterpart device receives the response (handover response) to the handover request transmitted by using the NFC communication module 26 from the mobile phone 1-1 by the NFC communication module 26, the mobile phone 1-2 notifies the Bluetooth communication module 25 of the handover request as in the mobile phone 1-1, and switches the communication mode from the NFC communication module 26 to the Bluetooth communication module 25 for the pairing with the mobile phone 1-1 by using the Bluetooth communication module 25 (step S34 of FIG. 4).

In step S5, the communication mode switching controller 31 of the mobile phone 1-1 notifies the authentication controller 33 of the pairing request included in the handover request. That is, the communication mode switching controller 31 notifies the authentication controller 33 of the fact that the pairing with another mobile phone 1-2 for which the handover request has been permitted is started by switching the communication mode from the communication mode by the NFC communication module 26 to the communication mode by the Bluetooth communication module 25 based on the handover request.

In step S6, the authentication controller 33 determines whether or not the counterpart device (another mobile phone 1) for which the handover request has been permitted is an already registered (paired) counterpart device based on the pairing request (the pairing request corresponding to the handover request) included in the handover request notified from the communication mode switching controller 31.

Specifically, in another pairing control process before the pairing control process of FIG. 3 is executed, it is assumed that device information of the counterpart device requesting pairing in another pairing control process is already registered at the side of the mobile phone 1-1, and also another nickname (for example, a nickname of Zanzibar Blue or the like) as a name related to the counterpart device is already registered at the side of the mobile phone 1-1.

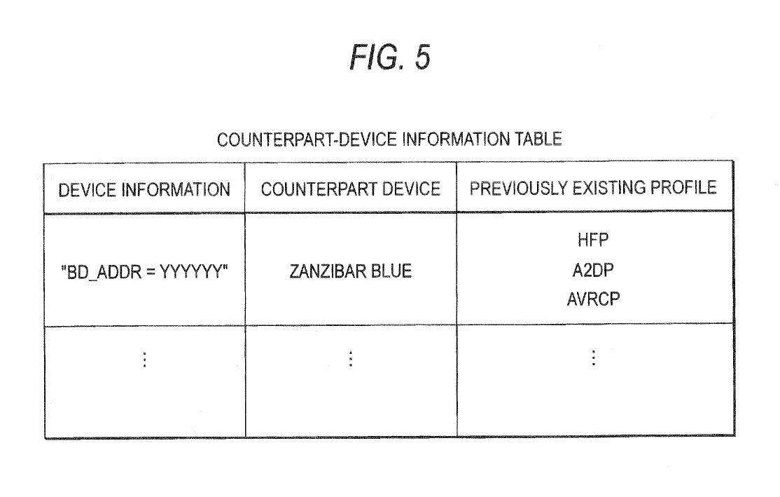

FIG. 5 shows a counterpart-device information table in which information regarding the counterpart device already performing the pairing using the Bluetooth communication module 25 is associated with the mobile phone 1-1. The counterpart-device information table is stored in the storage device 27. In the case of FIG. 5, the device information “BD_ADDR=YYYYYY” is associated with the name “Zanzibar Blue” of the counterpart device, and is also associated with profiles HFP, A2DP, and AVRCP of Bluetooth already executed by the mobile phone 1-1 with the counterpart device. The security information necessary for the authentication process at the time of establishing a connection with the counterpart device already registered (paired) at the side of the mobile phone 1-1 is associated and registered with the device information of the counterpart device.

The pairing request included in the handover request (the pairing request corresponding to the handover request) notified from the communication mode switching controller 31 includes device information (a device address) unique to another mobile phone 1-2 as the counterpart device for which the handover request has been permitted.

The authentication controller 33 reads a counterpart-device information table from the storage device 27, refers to the read counterpart-device information table, and determines whether or not the counterpart device (another mobile phone 1) for which the handover request has been permitted is the already registered (paired) counterpart device based on the device information included in the pairing request, notified from the communication mode switching controller 31.

When the authentication controller 33 determines that the counterpart device (another mobile phone 1) for which the handover request has been permitted is the already registered (paired) counterpart device in step S6, the authentication controller 33 discards the pairing request included in the handover request notified from the communication mode switching controller 31 without providing (reporting) the pairing request included in the handover request (the pairing request corresponding to the handover request) notified from the communication mode switching controller 31 to the pairing controller 32 in step S7 (step S35 of FIG. 4).

Thereby, the mobile phone 1-1 does not perform the pairing including the authentication process by the Bluetooth communication module 25 even though a connection request has been received from another mobile phone 1-2 as the counterpart device thereafter. In step S8, the controller 21 activates all previously executed Bluetooth profiles pre-associated with another mobile phone 1-2 as the counterpart device for which the handover request has been permitted by referring to the read counterpart-device information table in preparation for the connection request from another mobile phone 1-2 as the counterpart device for which the handover request has been permitted. (step S35 of FIG. 4).

Thereby, it is possible to activate all the previously executed profiles until a connection request is received from the counterpart device in relation to the already registered (paired) counterpart device, and it is possible to start wireless communication using the Bluetooth communication module 25 seamlessly from the NFC touch of another mobile phone 1-2 as the counterpart device and the mobile phone 1-1 as its own device. Of course, some of the previously executed Bluetooth profiles may be activated without having to activate all the previously executed Bluetooth profiles associated with another mobile phone 1-2 as the counterpart device for which the handover request has been permitted.

Thereafter, the mobile phone 1-2 transmits a connection request for requesting the establishment of a Bluetooth connection with the mobile phone 1-1 to the mobile phone 1-1 via the Bluetooth communication module 25 (step S36 of FIG. 4).

In step S9, the pairing controller 33 of the mobile phone 1-1 receives the connection request from the mobile phone 1-2 by using the Bluetooth communication module 25. In step S10, the pairing controller 33 of the mobile phone 1-1 transmits a response to the connection request to the mobile phone 1-2 by using the Bluetooth communication module 25 so as to start the Bluetooth communication between the two mobile phones 1 based on the received connection request (step S37 of FIG. 4).

In step S11, the pairing controller 33 of the mobile phone 1-1 executes the authentication process by using the Bluetooth communication module 25 based on the security information (associated and registered in advance to the corresponding device information table) necessary for the authentication process at the time of establishing the connection with the counterpart device (another mobile phone 1-2) already registered (paired) at the side of the mobile phone 1-1 without performing the pairing with another mobile phone 1 by using the Bluetooth communication module 25 based on the device information and the security information received from another mobile phone 1-2 in step S2, and establishes the Bluetooth connection between the mobile phone 1-1 and another mobile phone 1-2 for which the handover request has been permitted.

Thereby, it is possible for the communication terminal according to the first embodiment to prevent a useless re-pairing process form being executed, and to prevent a name (nickname) of the counterpart device (another communication terminal) resolutely changed by the user using the communication terminal from returning to an inorganic device name originally possessed by the counterpart device (to hold the registered name). In terms of the name of the counterpart device, the registered name is displayed by the display device 23.

On the other hand, when the authentication controller 33 determines that the counterpart device (another mobile phone 1) for which the handover request has been permitted is not the already registered (paired) counterpart device (or is the unregistered counterpart device) in step S6, the authentication controller 33 provides (reports) the pairing request included in the handover request notified from the communication mode switching controller 31 to the pairing controller 32 without discarding the pairing request included in the hangover request notified from the communication mode switching controller 31 in step S12.

Thereby, the mobile phone 1-1 may perform the pairing including the authentication process by the Bluetooth communication module 25 by receiving a connection request from another mobile phone 1-2 as the counterpart device thereafter. Thereafter, the mobile phone 1-2 transmits the connection request for requesting the establishment of the Bluetooth connection with the mobile phone 1-1 to the mobile phone 1-1 via the Bluetooth communication module 25 (step S36 of FIG. 4).

In step S13, the pairing controller 33 of the mobile phone 1-1 receives the connection request from the mobile phone 1-2 by using the Bluetooth communication module 25. In step S14, the pairing controller 33 of the mobile phone 1-1 transmits a response to the connection request to the mobile phone by using the Bluetooth communication module 25 so as to start the pairing process between the two mobile phones 1 based on the received connection request (step S37 of FIG. 4).

In step S15, the pairing controller 33 of the mobile phone 1-1 executes the authentication process by performing the pairing with another mobile phone 1 by using the Bluetooth communication module 25 based on the device information and the security information from another mobile phone 1-2 received in step S2, and also establishes the Bluetooth connection between the mobile phone 1-1 and another mobile phone 1-2 for which the handover request has been permitted by using the Bluetooth communication module 25 in step S16.

In terms of the mobile phone applicable to the communication terminal according to the first embodiment, a first wireless communication unit (the NFC communication module 26) is used to perform wireless communication between the communication terminal and the counterpart device (another mobile phone 1-1), and a second wireless communication unit (the Bluetooth communication module 25) is used to perform wireless communication between the communication terminal and the counterpart device.

When the first wireless communication unit receives a communication mode switching request for switching the communication mode from the first wireless communication unit to the second wireless communication unit from the counterpart device in the case where the communication terminal and the counterpart device are close to each other in a range where wireless communication by the first wireless communication unit is possible, a response to the communication mode switching request is transmitted to the counterpart device by using the first wireless communication unit, also the communication mode is switched from the first wireless communication unit to the second wireless communication unit based on the communication mode switching request, and the connection request received by the second wireless communication unit from the counterpart device is accepted.

The response to the connection request from the counterpart device is made by using the second wireless communication unit, and the pairing with the counterpart device is controlled using the second wireless communication unit based on device information and security information received from the counterpart device by using the first wireless communication unit.

It is determined whether or not the counterpart device for which the communication mode switching request has been permitted is the already registered counterpart device based on the pairing request corresponding to the notified communication mode switching request (the pairing request included in the communication mode switching request). In the case of determining that the counterpart device for which the communication mode switching request has been permitted is the already registered counterpart device, a control operation is performed to discard the pairing request corresponding to the notified communication mode switching request without performing the pairing including the authentication process by the second wireless communication unit.

The mobile phone applicable to the communication terminal according to the first embodiment configured as described above may preferably cancel (omit) the pairing process in relation to the already registered counterpart device even though the negotiation related to the switching of the communication mode is done using the first wireless communication unit. Accordingly, it is possible for the communication terminal to prevent a re-pairing process from being executed for the already registered counterpart device.

It is possible to prevent a name (nickname) of the counterpart device (the other communication terminal) resolutely changed by the user using the communication terminal from returning to an inorganic device name originally possessed by the counterpart device. After negotiation related to switching of the communication mode is done by using the NFC communication module 26 as the first wireless communication unit, it is possible to activate previously executed profiles pre-associated with the already registered counterpart device in preparation for a connection request from the counterpart device using the Bluetooth communication module 25 as the second wireless communication unit, and to seamlessly start wireless communication with the counterpart device.

As the second wireless communication unit in place of the Bluetooth communication module 25, a WLAN may be used and another wireless communication means (wireless communication system) may be used.

The series of processes described in the first embodiment may be executed by software, but may also be executed by hardware.

In the first embodiment, the steps of the flowchart have been shown as an example of the process to be executed chronologically according to the sequence noted on the flowchart. They also include a process to be executed in parallel or individually as well as the process to be chronologically executed.

Next, a mobile phone according to a second embodiment will be described with reference to the drawings. In the following description, description of components the same as or similar to those of the first embodiment is omitted.

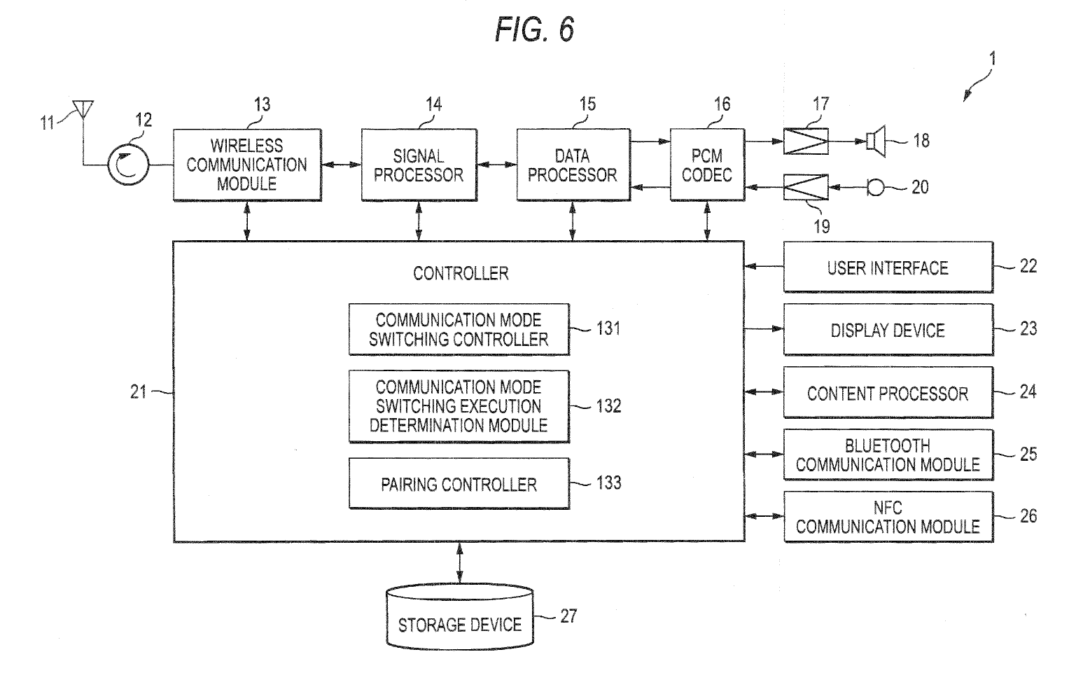

FIG. 6 shows the internal configuration of a mobile phone 1 applicable to a communication terminal according to the second embodiment. The mobile phone 1 includes an antenna 11, a sharing module 12, a wireless communication module 13, a signal processor 14, a data processor 15, a PCM codec 16, an output amplifier 17, a receiver 18, an input amplifier 19, a microphone 20, a controller 21, an user interface 22, a display device 23, a content processor 24, a Bluetooth communication module 25, an NFC communication module 26, and a storage device 27.

When the Bluetooth communication module 25 is not in an available state in the case where a handover request has been received from another mobile phone 1, the mobile phone 1 according to the second embodiment performs pairing including an authentication process by the Bluetooth communication module 25 after the state of the Bluetooth communication module 25 is changed to the available state.

The controller 21 includes a communication mode switching controller 131, a communication mode switching execution determination module 132, and a pairing controller 133.

The communication mode switching controller (handover controller) 131 of the controller 21 controls a process of acquiring device information and security information of the counterpart device, which is necessary at the time of pairing with the counterpart device (the mobile phone 1 or the like) which performs short-distance wireless communication using the Bluetooth communication module 25, from the counterpart device by using a communication mode (for example, the wireless communication mode of NFC or the like) other than Bluetooth.

Specifically, at the time of pairing with the counterpart device which performs the short-distance wireless communication by using the Bluetooth communication module 25, the communication mode switching controller 131 controls the NFC communication module 26, negotiates with another mobile phone 1 located in the vicinity of the mobile phone 1 by using the NFC communication module 26, receives the handover request from another mobile phone 1 upon negotiation, exchanges security information or device information (information including device address or the like) unique to each other's mobile phone 1, decides a communication mode (for example, a communication mode by the Bluetooth communication module 25) of a switching destination from the NFC communication mode, and controls switching directed to the switching destination (handover).

After deciding a communication mode of a switching destination upon receipt of handover request, the communication mode switching controller 131 reports an inquiry about handover availability (handover availability inquiry) to the communication mode switching execution unit 132 before a response to the hangover request is transmitted to another mobile phone 1 as the counterpart device. The communication mode switching controller 131 controls the switching (handover) directed to the communication mode of the switching destination according to the response to the handover availability inquiry.

The communication mode switching execution determination module (handover execution determination module) 132 controls the Bluetooth communication module 25, and determines whether or not the Bluetooth communication module 25 is in an available state upon receipt of the handover availability inquiry from the communication mode switching controller 131 after the communication mode of the switching destination is decided by the communication mode switching controller 131 upon receipt of the handover request. Here, a state in which the Bluetooth communication module 25 is available means “a state of waiting for a Bluetooth connection request (that is, a state in which the connection request from the counterpart device can be accepted)”.

In the case of determining that the Bluetooth communication module 25 is in the available state, the communication mode switching execution unit 132 notifies the communication mode switching controller 131 of a response to the handover availability inquiry (a response indicating that the handover is possible).

On the other hand, in the case of determining that the Bluetooth communication module 25 is not in the available state, the communication mode switching execution unit 132 notifies the communication mode switching controller 131 of a response to the handover availability inquiry (a response indicating that the so handover is impossible), and also controls the Bluetooth communication module 25 to change the state of the Bluetooth communication module 25 to the available state. When the state of the Bluetooth communication module 25 is changed to the available state, the communication mode switching execution determination module 132 reports the response to the handover availability inquiry (the response indicating that the handover is possible) to the communication mode switching controller 131.

The pairing controller 133 controls the pairing with the counterpart device (another mobile phone 1) which performs short-distance wireless communication by using the Bluetooth communication module 25. For example, the pairing is a pairing type called Secure. Simple Pairing (SSP).

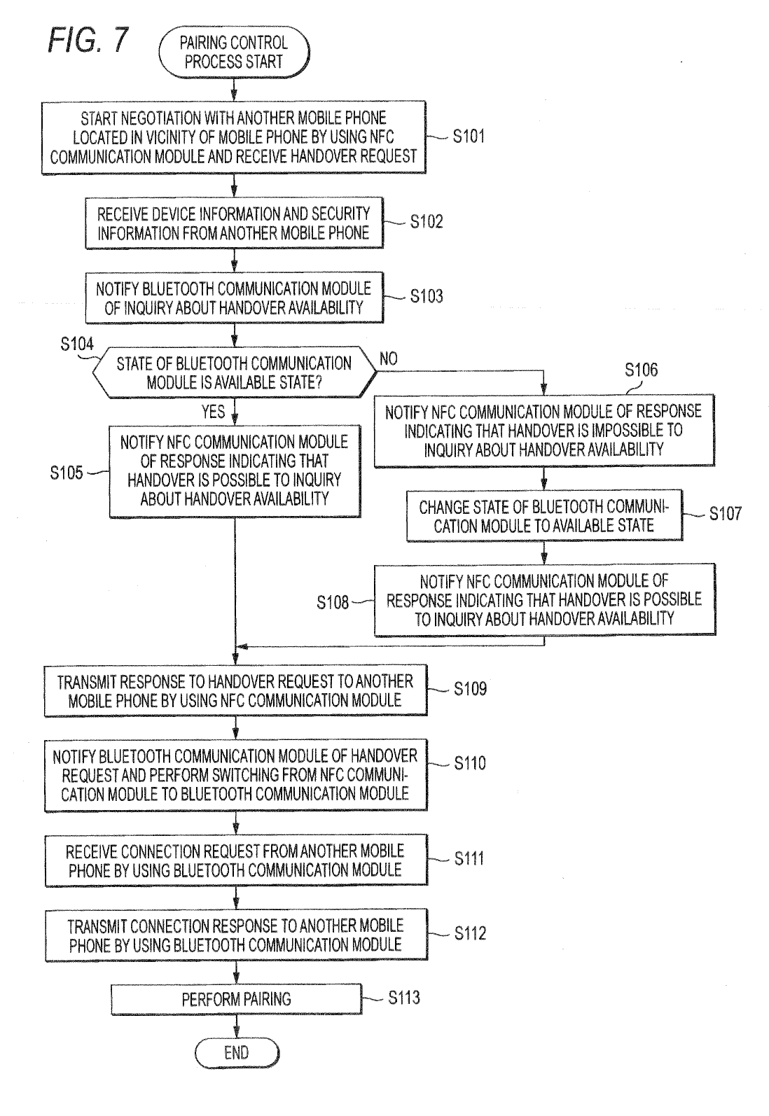

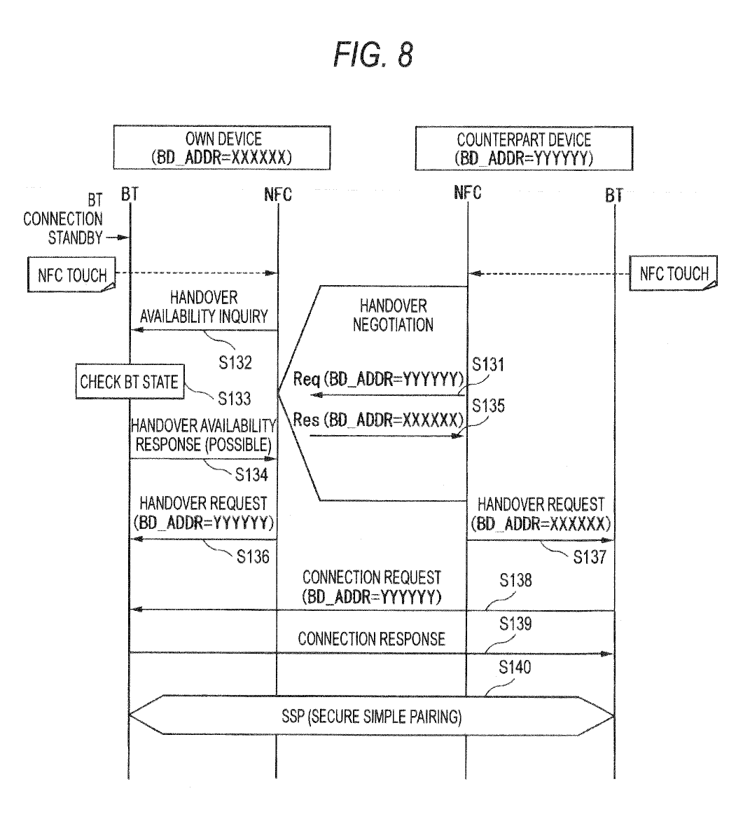

A pairing control process in the mobile phone 1-1 of FIG. 6 when the mobile phone 1-1 and the mobile phone 1-2 are paired using the Bluetooth communication modules 25 will be described with reference to the flowchart of FIG. 7. The pairing control process is executed by the mobile phone 1-1 when the NFC touch is done between the two mobile phones in the case where the mobile phone 1-1 waits for a Bluetooth communication connection. FIG. 8 shows a sequence of a specific process between the mobile phone 1-1 (its own device) and the mobile phone 1-2 (counterpart device) when the pairing control process illustrated by using the flowchart of FIG. 7 is executed.

In step S101, the communication mode switching controller 131 of the mobile phone 1-1 starts negotiation with another mobile phone 1-2 located in the vicinity of the mobile phone 1 by using the NFC communication module 26 when the NFC touch is done between the mobile phone 1-1 and the mobile phone 1-2. The NFC communication module 26 of the mobile phone 1-1 receives the handover request from another mobile phone 1-2 during negotiation with another mobile phone (step S131 of FIG. 8). The handover request includes security information and device information (information including a device address or the like) unique to another mobile phone 1-2. The device information unique to another mobile phone 1-2 is “BD_ADDR=YYYYYY”. On the other hand, the device, information unique to its own mobile phone 1-1 is “BD_ADDR=XXXXXX”.

In step S102, the communication mode switching controller 131 of the mobile phone 1-1 acquires the security information and the device information unique to another mobile phone 1-2 from the handover request received by the NFC communication module 26. The communication mode switching controller 131 of the mobile phone 1-1 provides the pairing controller 133 with the received security information and the received device information unique to another mobile phone 1-2.

In step S103, the communication mode switching controller 131 of the mobile phone 1-1 sets the communication mode of the switching destination from the NFC communication mode to the communication mode by the Bluetooth communication module 25. After deciding a communication mode of a switching destination upon receipt of a handover request, the communication mode switching controller 131 reports an inquiry about handover availability (handover availability inquiry) to the communication mode switching execution unit 132 before a response to the handover request is transmitted to another mobile phone 1-2 as the counterpart device (step S132 of FIG. 8).

In step S104, the communication mode switching execution determination module (handover execution determination module) 132 controls the Bluetooth communication module 25, and determines whether or not the Bluetooth communication module 25 is in an available state upon receipt of the handover availability inquiry from the communication mode switching controller 131 after the communication mode of the switching destination is decided by the communication mode switching controller 131 upon receipt of the handover request.

In the case of determining that the Bluetooth communication module 25 is in the available state in step S104, the communication mode switching execution unit 132 notifies the communication mode switching controller 131 of a response to the handover availability inquiry (a response indicating that the handover is possible) in step S105 (step S134 of FIG. 8). When the state of the Bluetooth communication module 25 is the available state upon receipt of the response indicating that the handover is possible from the communication mode switching execution determination module 132, the communication mode switching controller 131 recognizes that it is possible to switch the communication mode from the NFC communication module 26 to the Bluetooth communication module 25.

Thereafter, in step S109, the communication mode switching controller 131 transmits the response to the handover request (the handover response) to another mobile phone 1-2 by using the NFC communication module 26 at the time of recognizing that it is possible to switch the communication mode from the NFC communication module 26 to the Bluetooth communication module 25 (step S135 of FIG. 8).

On the other hand, when the communication mode switching execution unit 132 determines that the Bluetooth communication module 25 is not in the available state in step S104, the communication mode switching execution unit 132 notifies the communication mode switching controller 131 of a response to the handover availability inquiry (a response indicating that the handover is impossible) in step S106. In step. S107, the communication mode switching execution determination module 132 controls the Bluetooth communication module 25 to change the state of the Bluetooth communication module 25 to the available state, and starts to prepare for a connection by the Bluetooth communication module 25. When the state of the Bluetooth communication module 25 is changed to the available state, the communication mode switching execution determination module 132 reports the response to the handover availability inquiry (the response indicating that the handover is possible) to the communication mode switching controller 131 in step S108. The communication mode switching controller 131 is notified of the response to the handover availability inquiry (the response indicating that the handover is impossible) once in the case of the pairing control process of FIG. 7, but this process may be omitted. Thereafter, the process proceeds to step S109.

In step S110, the communication mode switching controller 131 notifies the Bluetooth communication module 25 of the handover request (the request for switching the communication mode from the communication mode by the NFC communication module 26 to the communication mode by the Bluetooth communication 25), and switches the communication mode from the NFC communication module 26 to the Bluetooth communication module 25 for the pairing using the Bluetooth communication module 25 (step S136 of FIG. 8).

At this time, when the mobile phone 1-2 as the counterpart device receives the response (handover response) to the handover request transmitted by using the NFC communication module 26 from the mobile phone 1-1 by the NFC communication module 26, the mobile phone 1-2 notifies the Bluetooth communication module of the handover request as in the mobile phone 1-1, and switches the communication mode from the NFC communication module 26 to the Bluetooth communication module 25 for the pairing with the mobile phone 1-1 using the Bluetooth communication module 25 (step S137 of FIG. 8).

At this time, the communication mode switching controller 131 of the mobile phone 1-1 notifies the pairing controller 133 of the fact that the pairing with another mobile phone 1-2 for which the handover request has been permitted is started by switching the communication mode from the communication mode by the NFC communication module 26 to the communication mode by the Bluetooth communication module 25 based on the handover request.

Thereafter, the mobile phone 1-2 transmits a connection request for requesting the establishment of the Bluetooth connection with the mobile phone 1-1 to the mobile phone 1-1 via the Bluetooth communication module 25 (step S138 of FIG. 8). In step S111, the pairing controller 133 of the mobile phone 1-1 receives the connection request from the mobile phone 1-2 by using the Bluetooth communication module 25. In step S112, the pairing controller 133 of the mobile phone 1-1 transmits a response to the connection request to the mobile phone 1-2 by using the Bluetooth communication module 25 so as to start the pairing process between the two bile phones 1 based on the received connection request (step S139 of FIG. 8).

In step S113, the pairing controller 133 of the mobile phone 1-1 controls the pairing with another mobile phone 1 which performs short-distance wireless communication using the Bluetooth communication module 25 based on the device information and the security information received from another mobile phone 1-2 in step S102 (step S140 of FIG. 8). For example, the pairing is a pairing type called Secure Simple Pairing (SSP). Thereby, the Bluetooth connection is established between the mobile phone 1-1 and the mobile phone 1-2.

In terms of the mobile phone according to the second embodiment, a first wireless communication unit (the NBC communication module 26) is used to perform wireless communication between the communication terminal and the counterpart device, and a second wireless communication unit (the Bluetooth communication module 25) is used to perform wireless communication between the communication terminal and the counterpart device. When the first wireless communication unit receives a communication mode switching request for switching the communication mode from the first wireless communication unit to the second wireless communication unit from the counterpart device in the case where the communication terminal and the counterpart device are close to each other in a range where wireless communication by the first wireless communication unit is possible, it is determined whether or not the state of the second wireless communication unit is the available state. In the case of determining that the state of the second wireless communication is the available state, response to the communication mode switching request is transmitted to the counterpart device by using the first wireless communication unit, and also the communication mode is switched from the first wireless communication unit to the second wireless communication unit based on the communication mode switching request. When the second wireless communication unit receives the connection request from the counterpart device, the pairing with the counterpart device is controlled using the second wireless communication unit based on the device information and the security information received from the counterpart device by using the first wireless communication unit.

After negotiation related to switching of the communication mode is done using the NFC communication module 26 as the first wireless communication unit, it is risible for the mobile phone according to the second embodiment to reliably receive a connection request from the counterpart device by using the Bluetooth communication module 25 as the second wireless communication unit and to seamlessly establish the connection.

As the second wireless communication unit in place of the Bluetooth communication module 25, a WLAN may be used and another wireless communication means (wireless communication system) may be used.

However, until Secure Simple Pairing (SSP) by Bluetooth is started by performing the handover from the NFC communication mode to the Bluetooth communication mode after the mobile phone 1 negotiates with a first counterpart device (counterpart device A) in relation to the handover by using NFC, the mobile phone 1 may receive a connection request from a second counterpart device (counterpart device C) different from the first counterpart device (counterpart device A) with which the mobile phone 1 has negotiated in relation to the handover by using NFC.

This is because it is possible to perform data communication between the mobile phones 1 located at a distance of about 10 to 30 cm only by a simplified security check procedure in the case of short-distance wireless communication using NFC.

As a result, even though the mobile phone 1 has received the connection request from the first counterpart device (counterpart device A) after receiving a pairing request from the second counterpart device (counterpart device C), the mobile phone 1 may not accept an SSP request (authentication request) based on the connection request from the first counterpart device (counterpart device A) in spite of the fact that the handover directed to Bluetooth for the first counter device (counterpart device A) has been permitted.

Until authentication by the Bluetooth communication module 25 is started after negotiation related to switching of the communication mode is done using the NFC communication module 26, the mobile phone 1 according to the second embodiment accepts only the connection request from the first counterpart device (counterpart device A) for which the handover request has been permitted, and also executes a guard process (rejection) so that a pairing request from other counterpart devices is not accepted. Preferably, the connection request from a desired counterpart device using the Bluetooth communication module 25 may be accepted. Hereinafter, a pairing control process using the above-described method will be described.

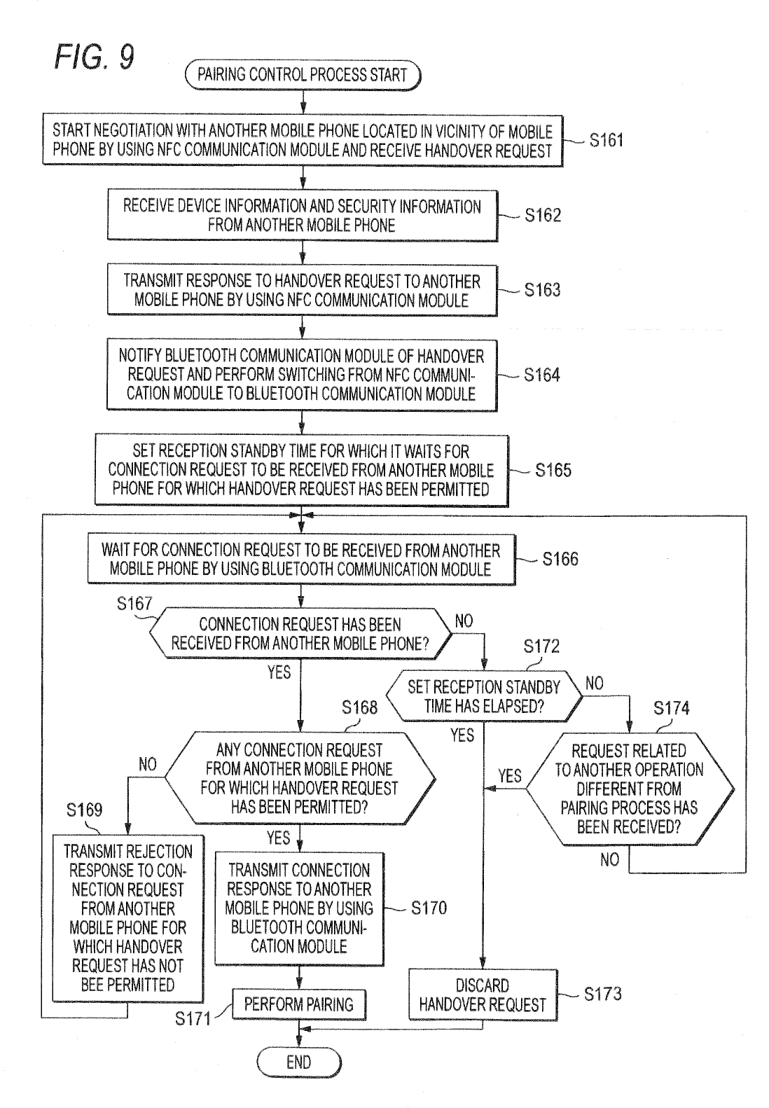

Another pairing control process in the mobile phone 1-1 of FIG. 6 when the mobile phone 1-1 and the mobile phone 1-2 are paired using the Bluetooth communication modules 25 will be described with reference to the flowchart of FIG. 9. The pairing control process is executed by the mobile phone 1-1 when the NFC touch is done between the two mobile phones in the case where the mobile phone 1-1 waits for a Bluetooth communication connection.

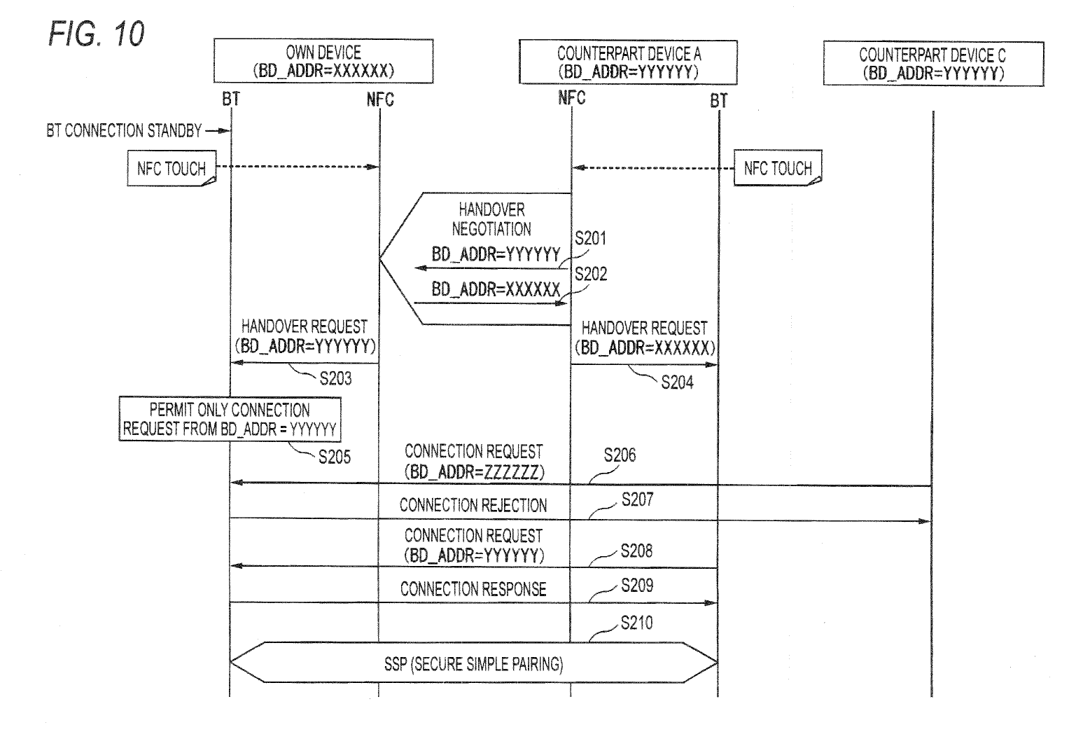

FIG. 10 shows a sequence of a specific process between the mobile phone 1-1 (its own device) and the mobile phone 1-2 (counterpart device) when the pairing control process illustrated by using the flowchart of FIG. 9 is executed. The process of steps S161 to S164 of FIG. 9 is the same as the process of steps S101, S102, S109, and S110 of FIG. 7, and thus repeated description thereof is omitted. The process of step S201 to S204 in the sequence diagram of FIG. 10 is the same as the process of steps S131 and S135 to S137 in the sequence diagram of FIG. 8.

In step S164, the communication mode switching controller 131 of the mobile phone 1-1 notifies the Bluetooth communication module 25 of the handover request (the request for switching the communication mode from the communication mode by the NFC communication module 26 to the communication mode by the Bluetooth communication 25), and switches the communication mode from the NFC communication module 26 to the Bluetooth communication module 25 for the pairing using the Bluetooth communication module 25 (step S203 of FIG. 10).

At this time, the communication mode switching controller 131 of the mobile phone 1-1 notifies the pairing controller 133 of the fact that pairing with another mobile phone 1-2 for which the handover request has been permitted by switching the communication mode from the communication mode by the NFC communication module 26 to the communication mode by the Bluetooth communication module 25 based on the handover request.

In step S165, the pairing controller 133 of the mobile phone 1-1 sets a reception standby time in which it waits for a connection request to be received from another mobile phone 1-2 for which the hangover request has been permitted to a given time (for example, a period of 10 sec or the like) by using a clock circuit. In step S166, the pairing controller 133 of the mobile phone 1-1 waits for a connection request to be received from another mobile phone 1-2 for which the handover request has been permitted by using the Bluetooth communication module 25.

At this time, the pairing controller S133 of the mobile phone 1-1 permits and receives only the connection request from another mobile phone 1-2 for which the handover request has been permitted (step S205 of FIG. 10). At this time, the pairing controller 133 of the mobile phone 1-1 determines whether or not the received connection request is the connection request from another mobile phone 1-2 for which the handover request has been permitted based on a device address included in the received connection request from another mobile phone 1 other than the mobile phone 1-1. Device information (a device address) unique to another mobile phone 1-2 for which the handover request has been permitted is “BD_ADDR=YYYYYY”.

In step S167, the pairing controller 133 of the mobile phone 1-1 controls the Bluetooth communication module 25 and determines whether or not a connection request has been received from another mobile phone 1 other than the mobile phone 1-1. When the pairing controller 133 determines that a connection request has been received from another mobile phone 1 other than the mobile phone 1-1 in step S167, the pairing controller 133 determines whether or not the connection request received from another mobile phone 1 other than the mobile phone 1-1 is the connection request from another mobile phone 1-2 for which the handover request has been permitted in step S168.

When the pairing controller 133 of the mobile phone 1-1 determines that the connection request received from mobile phone 1 is not the connection request from another mobile phone 1-2 for which the handover request has been permitted in step S168, the pairing controller 133 of the mobile phone 1-1 transmits a rejection response to the connection request from another mobile phone 1 for which the handover request has not been permitted by using the Bluetooth communication module 25 in step S169 (steps S206 and S207 of FIG. 10).

When the connection request is received from another mobile phone 1 (counterpart device C) for which the handover request has not been permitted in step S206 of FIG. 10, the mobile phone 1-1 transmits a rejection response to the connection request from another mobile phone 1 (counterpart device C) for which the handover request has not been permitted in step S207 of FIG. 10. Thereby, it is possible to execute a guard process (rejection) so that a pairing request from another mobile phone 1 (counterpart device C) for which the hangover request has not been permitted is not accepted.

Thereafter, the process returns to S166 in which the mobile phone 1-1 waits for the connection request to be received from another mobile phone 1.

On the other hand, when the pairing controller 133 of the mobile phone 1-1 determines that the connection request received from another mobile phone 1 is the connection request from another mobile phone 1-2 for which the handover request has been permitted in step S168, the pairing controller 133 of the mobile phone 1-1 transmits a response to the connection request by using the Bluetooth communication module 25 to the mobile phone 1-2 so as to start the pairing process between two mobile phones 1 based on the received connection request in step S170 (step S208 of FIG. 10).

In step S171, the pairing controller 133 of the mobile phone 1-1 controls the pairing with another mobile phone 1 by using the Bluetooth communication module 25 based on the device information and the security information received from another mobile phone 1-2 in step S162 (step S210 of FIG. 10).

On the other hand, when the pairing controller 133 determines that a connection request has not been received from another mobile phone 1 other than the mobile phone 1-1 in step S167, the pairing controller 133 of the mobile phone 1-1 determines whether or not a set reception standby time has elapsed in step S172.

When the pairing controller 133 of the mobile phone determines that the set reception standby time has not elapsed in step S172, the pairing controller 133 of the mobile phone 1-1 determines whether or not a request related to another operation different from the pairing process by the user operating the user interlace 22 has been accepted in step S174.

When the pairing controller 133 of the mobile phone 1-1 determines that a request related to another operation different from the purring process by the user operating the user interface 22 has not been accepted in step S174, the process returns to step S166 in which it continues to wait for a connection request to be received from another mobile phone 1 until the set reception standby time has elapsed.

On the other hand, when the pairing controller 133 of the mobile phone 1-1 determines that the set reception standby time has elapsed in step S172 or determines that the request related to another operation different from the pairing process has been accepted in step S174, the pairing controller 133 of the mobile phone 1-1 notifies the communication mode switching controller 131 of the fact that the set reception standby time has elapsed or that the request related to another operation different from the pairing process has been accepted. In step S173, the communication mode switching controller 131 discards the handover request received from another mobile phone 1-2. Thereafter, the pairing process is ended.

In terms of the mobile phone according to the second embodiment, a first wireless communication unit is used to perform wireless communication between the communication terminal and the first counterpart device, and a second wireless communication unit is used to perform wireless communication between the communication terminal and the first counterpart device. When the first wireless communication unit receives a communication mode switching request for switching the communication mode from the first wireless communication unit to the second wireless communication unit from the first counterpart device in the case where the communication terminal and the first counterpart device are close to each other in a range where wireless communication by the first wireless communication unit is possible, a response to the communication mode switching request is transmitted to the first counterpart device by using the first wireless communication unit. Also, the communication mode is switched from the first wireless communication unit to the second wireless communication unit based on the communication mode switching request, only the connection request received by the second wireless communication unit from the first counterpart device is accepted, a response to the connection request from the first counterpart device is made by using the second wireless communication unit, and pairing with the first counterpart device is controlled using the second wireless communication unit based on the device information and the security information from the first counterpart device received by using the first wireless communication unit.

Thereby, when the mobile phone waits for a connection request to be received from other mobile phone by using the Bluetooth communication module 25, the mobile phone according to the second embodiment accepts only the connection request from the first counterpart device for which the handover request has been permitted until authentication by the Bluetooth communication module 25 is started after negotiation related to switching of the communication mode is done by using the NFC communication module 26. Also, the mobile phone executes a guard process (rejection) so that a pairing request from other counterpart devices is not accepted. Preferably, the connection request from a desired counterpart device using the Bluetooth communication module 25 may be accepted.

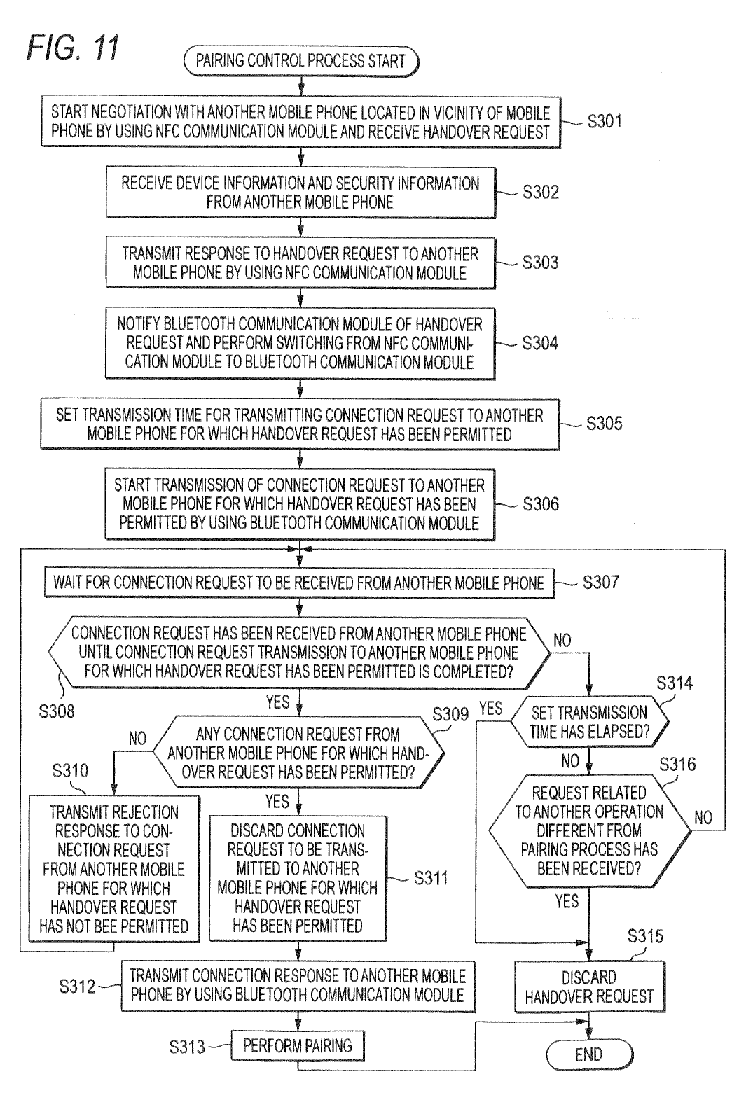

The case where the mobile phone 1-1 waits for a connection request to be received from another mobile phone 1-2 by using the Bluetooth communication module 25 has been described in the case of FIGS. 9 and 10, but the present invention is not limited thereto. For example, the present invention is also applicable to the case where the mobile phone 1-1 transmits a connection request to another mobile phone 1-2 by using the Bluetooth communication module 25. In this case, a pairing control process is shown in the flowchart of FIG. 11.

Another pairing control process in the mobile phone 1-1 of FIG. 6 when the mobile phone 1-1 and the mobile phone 1-2 are paired using the Bluetooth communication modules 25 will be described with reference to the flowchart of FIG. 11. The process of steps S301 to S304 of FIG. 11 is the same as the process of steps S101, S10, S109, and S110 of FIG. 7, and thus repeated description thereof is omitted.

In step S304, the communication mode switching controller 131 of the mobile phone 1-1 notifies the Bluetooth communication module 25 of the hangover request (the request for switching the communication mode from the communication mode by the NFC communication module 26 to the communication mode by the Bluetooth communication 25), and switches the communication mode from the NFC communication module 26 to the Bluetooth communication module 25 for the pairing using the Bluetooth communication module 25.

At this time, the communication mode switching controller 131 of the mobile phone 1-1 notifies the pairing controller 133 of the start of pairing with another mobile phone 1-2 for which the handover request has been permitted by switching the communication mode from the communication mode by the NFC communication module 26 to the communication mode by the Bluetooth communication module 25 based on the handover request.

In step S305, the pairing controller 133 of the mobile phone 1-1 sets a reception standby time in which it waits for connection request to be received from another mobile phone 1-2 for which the handover request has been permitted to a given time (for example, a period of 10 sec or the like) by using a clock circuit. In step S300, the pairing controller 133 of the mobile phone 1-1 starts the transmission of connection request to another mobile phone 1-2 for which the hangover request has been permitted by using the Bluetooth communication module 25.

In step S3307, the pairing controller 133 of the mobile phone 1-1 waits for the connection request to be received from another mobile phone 1-2 for which the handover request has been permitted by using the Bluetooth communication module 25. At this time, the pairing controller 133 of the mobile phone 1-1 permits and accepts only the connection request from another mobile phone 1-2 for which the handover request has been permitted.

At this time, the pairing controller 133 of the mobile phone 1-1 determines whether or not the received connection request is the connection request from another mobile phone 1-2 for which the handover request has been permitted based on a device address included in the received connection request from a mobile phone 1 other than the mobile phone 1-1.

In step S308, the pairing controller 133 of the mobile phone 1-1 controls the Bluetooth communication module 25 and determines whether or not a connection request has been received from another mobile phone 1 other than the mobile phone 1-1 until the transmission of the connection request to another mobile phone 1-2 for which the handover request has been permitted is completed. When the paining controller 133 determines that connection request has been received from another mobile phone 1 other than the mobile phone 1-1 until the transmission of the connection request to another mobile phone 1-2 for which the handover request has been permitted is completed in step S308, the pairing controller 133 determines whether or not the connection request received from another mobile phone 1 other than the mobile phone 1-1 is the connection request from another mobile phone 1-2 for which the hangover request has been permitted in step S309. When the pairing controller 133 of the mobile phone 1-1 determines that the connection request received from another mobile phone 1 is not the connection request from another mobile phone 1-2 for which the handover request has been permitted in step S309, the pairing controller 133 of the mobile phone 1-1 transmits a rejection response to the connection request from another mobile phone 1 for which the hangover request has not been permitted by using the Bluetooth communication module 25 in step S310. Thereafter, the process returns to step S307 in which the mobile phone 1-1 waits for the connection request to be received from another mobile phone 1.

On the other hand, when the pairing controller 133 of the mobile phone 1-1 determines that the connection request received from another mobile phone 1 is the connection request from another mobile phone 1-2 for which the hangover request has been permitted until the transmission of the connection request to another mobile phone 1-2 for which the hangover request has been permitted is completed in step S309, the pairing controller 133 of the mobile phone 1-1 discards the connection request (the connection request from its own device) to be transmitted to another mobile phone 1-2 for which the handover request has been permitted in step S311. In step S312, the pairing controller 133 of the mobile phone 1-1 transmits a response to the connection request to the mobile phone 1-2 by using the Bluetooth communication module 25 so as to start the pairing process between the two mobile phones based on the received connection request. In step S313, the pairing controller 13 of the mobile phone 1-1 controls the pairing with another mobile phone 1 by using the Bluetooth communication module 25 based on the device information and the security information received from another mobile phone 1-2 in step S302.

On the other hand, when the pairing controller 133 determines that a connection request has not been received from another mobile phone 1 other than the mobile phone 1-1 until the transmission of the connection request to another mobile phone 1-2 for which the handover request has been permitted is completed in step S308, the pairing controller 133 of the mobile phone 1-1 determines whether or not a set reception standby time has elapsed in step S314. When the pairing controller 133 of the mobile phone 1-1 determines that the set reception standby time has not elapsed in step S314, the pairing controller 133 of the mobile phone 1-1 determines whether or not a request related to another operation different from the pairing process by the user operating the user interface 22 has been accepted iii step S316. When the pairing controller 133 of the mobile phone 1-1 determines that a request related to another operation different from the pairing process by the user operating the user interface 22 has not been accepted in step S316, the process returns to step S307 in which it continues to wait for a connection request to be received from another mobile phone 1 until the set reception standby time has elapsed as long as the transmission of the connection request to another mobile phone 1-2 for which the handover request has been permitted is not completed. On the other hand, when the pairing controller 133 of the mobile phone 1-1 determines that the set reception standby time has elapsed in step S314 or determines that the request related to another operation different from the pairing process has been accepted in step S316, the pairing controller 133 of the mobile phone 1-1 notifies the communication mode switching controller 131 of the fact that the set reception standby time has elapsed or that the request related to another operation different from the pairing process has been accepted. In step S315, the communication mode switching controller 131 discards the handover request received from another mobile phone 1-2. Thereafter, the pairing process is ended.

In terms of the mobile phone according to the second embodiment, first wireless communication unit is used to perform wireless communication between the communication terminal and the first counterpart device, and a second wireless communication unit is used to perform wireless communication between the communication terminal and the first counterpart device. When the first wireless communication unit receives a communication mode switching request for switching the communication mode from the first wireless communication unit to the second wireless communication unit from the first counterpart device in the case where the communication terminal and the first counterpart device are close to each other in a range where wireless communication by the first wireless communication unit is possible, a response to the communication mode switching request is transmitted to the first counterpart device by using the first wireless communication unit. Also, the communication mode is switched from the first wireless communication unit to the second wireless communication unit based on the communication mode switching request, only the connection request received by the second wireless communication unit from the first counterpart device is accepted when the communication terminal transmits the connection request to the first counterpart device, a response to the connection request from the first counterpart device is made using the second wireless communication unit, and pairing with the first counterpart device is controlled using the second wireless communication unit based on the device information and the security information received from the first counterpart device by using the first wireless communication unit.

When the mobile phone 1-1 transmits a connection request to another mobile phone 1-2 by using the Bluetooth communication module 25, the mobile phone according to the second embodiment accepts only the connection request from the first counterpart device for which the handover request has been permitted until authentication by the Bluetooth communication module 25 is started after negotiation related to switching of the communication mode is done using the NFC communication module 26. Also, the mobile phone executes a guard process (rejection) so that a pairing request from other counterpart devices is not accepted. Preferably, the connection request from a desired counterpart device using the Bluetooth communication module 25 may be accepted.

The series of processes described in the second embodiment may be executed by software, but may also be executed by hardware.

In the second embodiment, the steps of the flowchart have been shown as an example of the process to be executed chronologically according to the sequence noted on the flowchart. They also include a process to be executed in parallel or individually as well as the process to be chronologically executed.

Next, a mobile phone according to a third embodiment will be described with reference to the drawings. In tire following description, description of components the same as or similar to those of the first and second embodiments is omitted.

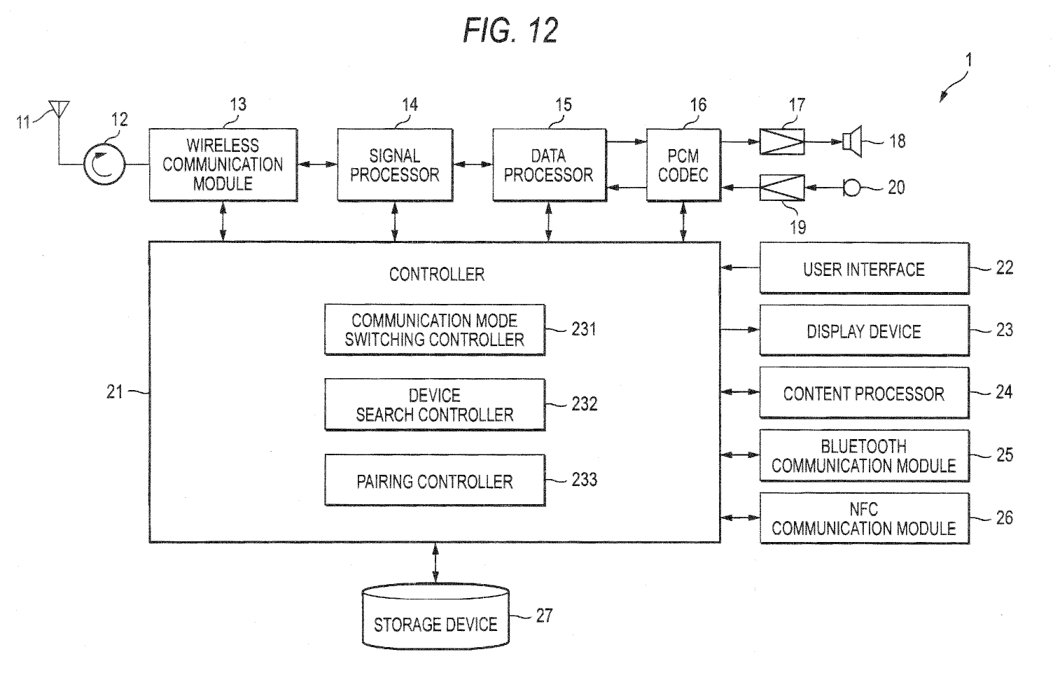

FIG. 12 shows the internal configuration of a mobile phone 1 applicable to a communication terminal according to the third embodiment. The mobile phone 1 includes an antenna 11, a sharing module 12, a wireless communication module 13, a signal processor 14, a data processor 15, a PCM codec 16, an output amplifier 17, a receiver 18, an input amplifier 19, a microphone 20, controller 21, an user interface 22, a display device 23, a content processor 24, a Bluetooth communication module 25, an NFC communication module 26, and a storage device 27.

Here, the mobile phone 1 according to the third embodiment includes two short-distance wireless communication units of the Bluetooth communication module 25 and the NFC communication module 26 as described above. When the mobile phone 1 performs wireless communication using the Bluetooth communication module 25 with another mobile phone 1 (counterpart device) similarly having the two short-distance wireless communication units of the Bluetooth communication module 25 and the NFC communication module 26, device information (information including a device address or the like) unique to each other's mobile phone 1 is first exchanged by negotiation using each other's NFC communication module 26. Next, the mobile phones 1 perform pairing including an authentication process by each other's Bluetooth communication module 25 by using device information of another mobile phone 1 received by negotiation via the NFC communication module 26. Thereafter, the mobile phone 1 performs wireless communication with another mobile phone 1 by using the Bluetooth communication module 25.

Here, in a first step, first, the short-distance wireless communication is performed using the NFC communication module 26 in which a security check procedure is simplified. Thereafter, in a second step, an operation of switching to (taking over) short-distance wireless communication using the Bluetooth communication module 25 in which faster data communication than NFC communication is possible is defined as a “handover”. That is, the “handover” indicates switching of a short-distance wireless communication mode.

The device information of another mobile phone 1 received by negotiation via the NFC communication module 26 is included in a handover request received from another mobile phone 1 upon negotiation via the NFC communication module 26. When the mobile phone 1 according to the third embodiment has received the handover request from another mobile phone 1, the pairing including the authentication process is performed by the Bluetooth communication module 25.

The mobile phone 1 according to the third embodiment checks whether or not a communication unit applicable to the wireless communication mode of NFC is mounted after two mobile phones 1 are held at a close distance to an extent to which mutual NFC communication is possible upon initial registration of the counterpart device. At this time, the mobile phone 1 searches for a counterpart device in the background based on a device search process using the Bluetooth communication module 25 in preparation for the case where the communication unit applicable to the wireless communication mode of NFC is not mounted.

In the case where it is possible for the mobile phone 1 to perform a search for the counterpart device using the NFC communication module 26, succeed in the counterpart device search, and receive device information or the like from another mobile phone 1 as the counterpart device by negotiation via the NFC communication module 26, the device search process using the Bluetooth communication module 25 executed in the background is stopped.

In the case where it is possible for the mobile phone 1 to perform a search for the counterpart device using the NFC communication module 26, succeed in the counterpart device search, and receive device information or the like from another mobile phone 1 as the counterpart device by negotiation via the NFC communication module 26, the device search process using the Bluetooth communication module 25 executed in the background is stopped when the device search process is still in operation in the case where the communication mode is handed over from the NFC communication module 26 to the Bluetooth communication module 25 after a handover response is received from another mobile phone 1 while the device search process is temporarily continued as it is if the device search process using the Bluetooth communication module 25 is being executed in the background. The mobile phone 1 performs pairing including the authentication process by the Bluetooth communication module 25.

The controller 21 has communication mode switching controller 231, a device search controller 232, and a pairing controller 233. The communication mode switching controller (handover controller) 231 of the controller 21 controls a process of acquiring device information and security information of the counterpart device, which is necessary at the time of pairing with the counterpart device (the mobile phone 1 or the like) which performs short-distance wireless communication using the Bluetooth communication module 25, from the counterpart device by using a communication mode (for example, the wireless communication mode of NFC or the like) other than Bluetooth.

Specifically, at the time of pairing with the counterpart device which performs the short-distance wireless communication by using the Bluetooth communication module 25, the communication mode switching controller 231 controls the NFC communication module 26, negotiates with another mobile phone 1 located in the vicinity of the mobile phone 1 by using the NFC communication module 26, receives the handover request or the handover response from another mobile phone 1 upon negotiation, exchanges security information or device information (information including a device address or the like) unique to each other's mobile phone 1, decides a communication mode (for example, communication mode by the Bluetooth communication module 25) of a switching destination from the NFC communication mode, and controls switching directed to the switching destination (handover).

When the counterpart device is initially registered, the device search controller 232 performs a control operation to start the execution of the search for the counterpart device in the background based on the device search process using the Bluetooth communication module 25.

In the case where it is possible for the device search controller 232 to receive device information or the like from another mobile phone 1 as the counterpart device by negotiation via the NFC communication module 26 after succeeding in the search for the counterpart device using the NFC communication module 26 (when the counterpart device has been found using the NFC communication module 26), the device search process using the Bluetooth communication module 25 executed in the background is stopped.

In the case where it is possible for the device search controller 232 to receive device information or the like from another mobile phone 1 as the counterpart device by negotiation via the NFC communication module 26 after succeeding in the search for the counterpart device using the NFC communication module 26, the device search process using the Bluetooth communication module 25 executed in the background is stopped when the device search process is still in operation in the case where the communication mode is handed over from the USC communication module 26 to the Bluetooth communication module 25 after a handover response is received from another mobile phone 1 while the device search process is temporarily continued as it is if the device search process using the Bluetooth communication module 25 is being executed in the background.

Inc pairing controller 233 controls the pairing with the counterpart device (another mobile phone 1) which performs short-distance wireless communication by using the Bluetooth communication module 25. For example, the pairing is a pairing type called Secure Simple Pairing (SSP).

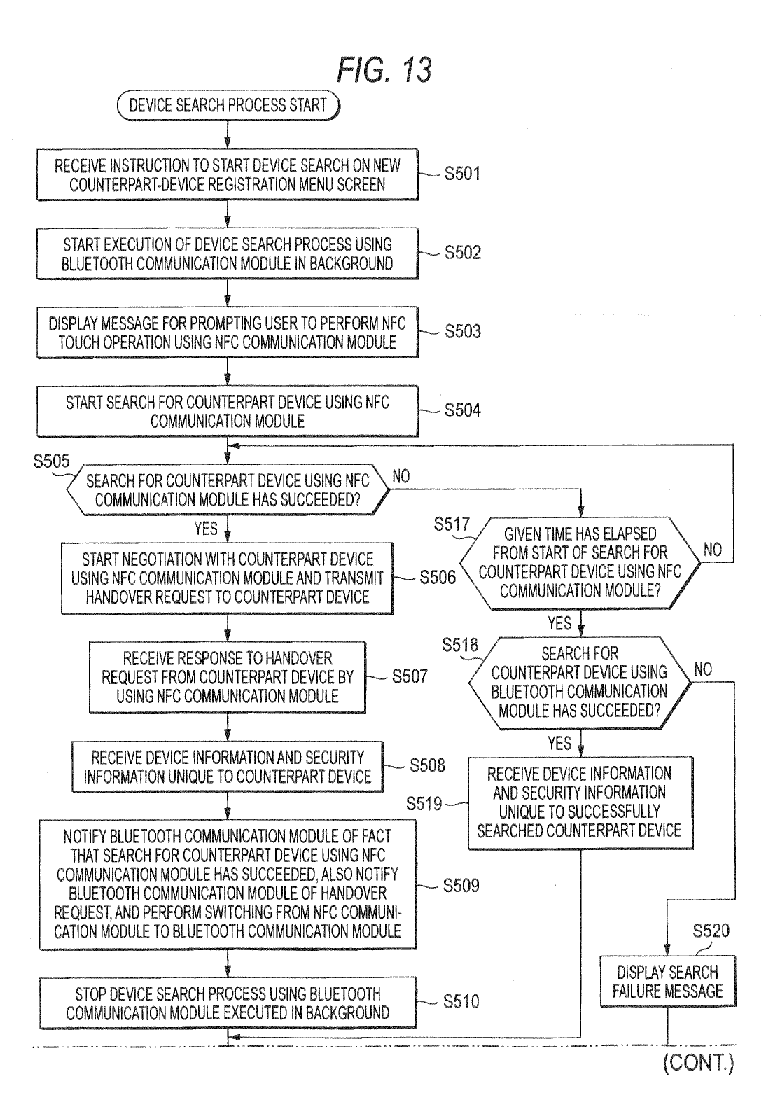

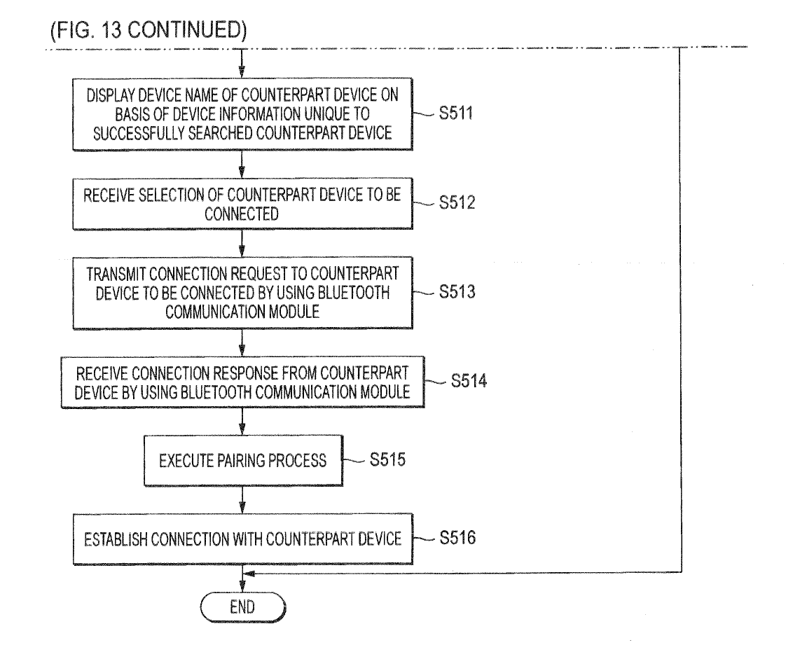

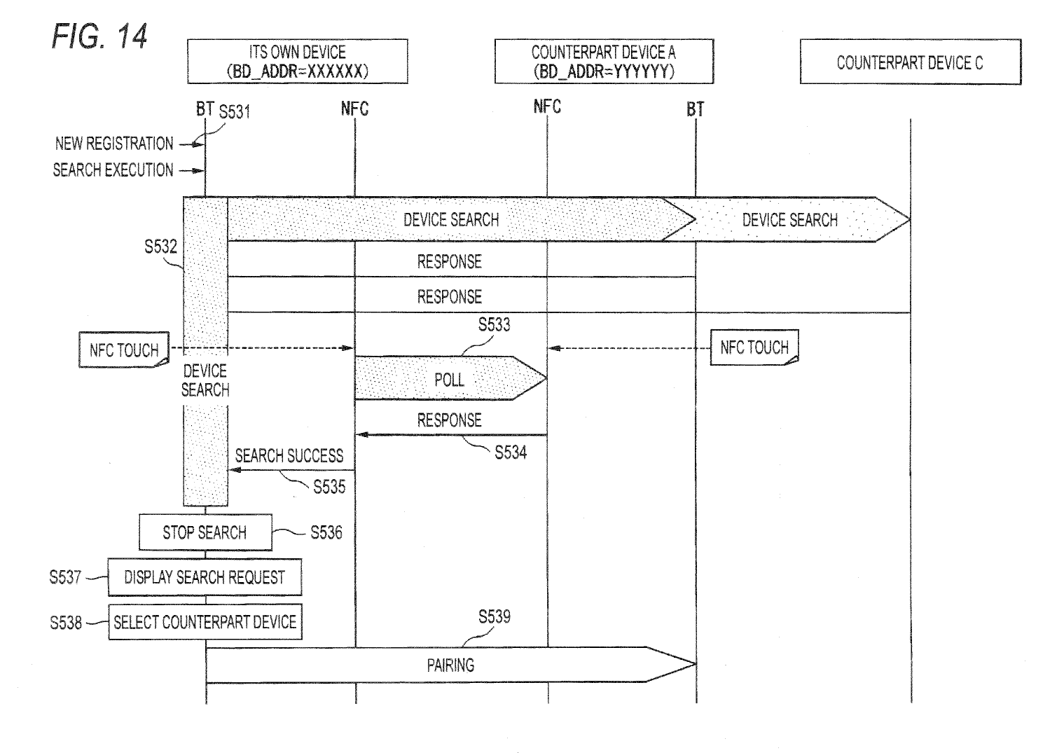

A device search process in the mobile phone 1-1 of FIG. 12 when the mobile phone 1-1 and the mobile phone 1-2 are paired using the Bluetooth communication modules 25 will be described with reference to the flowchart of FIG. 13. For example, when the counterpart device is initially registered, the device search process is executed by the mobile phone 1-1. FIG. 14 shows a sequence of a specific process between the mobile phone 1-1 (the device itself) and the mobile phone 1-2 (counterpart device) when the device search process illustrated by using the flowchart of FIG. 13 is executed.

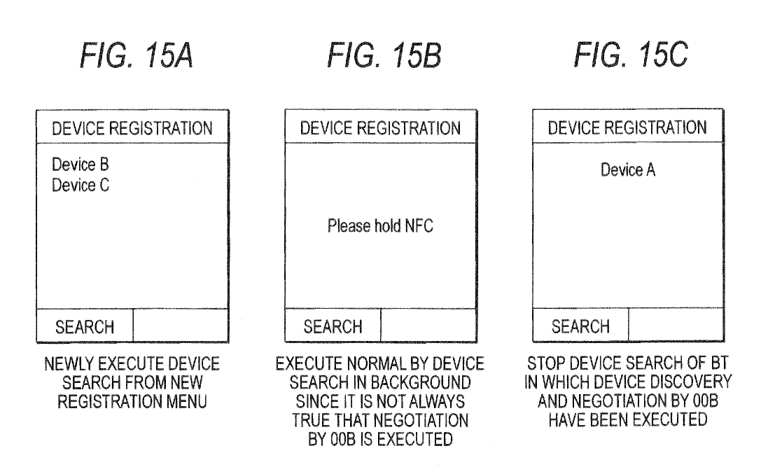

In step S501, the controller 21 of the mobile phone 1-1 receives an instruction to start a device search on a new counterpart device registration menu screen by the user operating the user interface 22 (step S531 of FIG. 14). FIG. 15A shows a display example of the new counterpart device registration menu screen displayed by the display device 23. As shown in FIG. 15A, a “search” command for starting the device search is displayed on the new counterpart device registration menu screen. The user can instruct the mobile phone 1-1 to start the device search by focusing on and pushing the “search” command by using the user interface 22.

In step S502, when the device search controller 232 of the mobile phone 1-1 receives the instruction for starting the device search, the execution of the device search process using the Bluetooth communication module 25 is started in the background (step S532 of FIG. 14). Here, “execution in the background” means that the device search process is executed in a state in which the device search process using the Bluetooth communication module 25 is not displayed on the screen.

In step S503, the controller 21 of the mobile phone 1-1 displays a message, which prompts the user to perform an NFC touch operation using the NFC communication module 26, on the display device 23. FIG. 15B shows a display screen displaying a message which prompts the user to perform the NFC touch operation using the NFC communication module 26. As shown in FIG. 15B, for example, the display device 23 displays the message “Please Hold NFC” on the counterpart device registration menu screen.

Thereby, the user can know that it is possible to search for desired counterpart device by NFC-touching the mobile phone 1-1 to the counterpart device (another mobile phone 1-2 or the like). Thereafter, the NFC touch operation is performed between the mobile phone 1-1 and the mobile phone 1-2 as another counterpart device. In this embodiment, when a counterpart device A and a counterpart device C are located in the of the mobile phone 1-1, it is assumed that the user NFC-touches the mobile phone 1-1 to the counterpart device A.

In step S501, the device search controller 232 of the mobile phone 1-1 starts a search for the counterpart device using the NFC communication module 26 when the NFC touch operation is performed between the mobile phone 1-1 and the mobile phone 1-2 (step S533 of FIG. 14). In step S505, the device search controller 232 determines whether or not the counterpart device has been found using the NFC communication module 26, that is, whether or not the search for the counterpart device using the NFC communication module has succeeded.

When the device search controller 232 determines that the search for the counterpart device using the NFC communication module has succeeded in step S505, the device search controller 232 notifies the communication mode switching controller 231 of the fact that the search for the counterpart device using the NFC communication module has succeeded. The communication mode switching controller 231 of the mobile phone 1-1 starts negotiation with another mobile phone 1-2 located in the vicinity of the mobile phone 1-1 by using the NFC communication module 26. The NFC communication module 26 of the mobile phone 1-1 transmits a handover request to another mobile phone 1-2 as the counterpart device during negotiation with another mobile phone 1-2 (step S533 of FIG. 14).

The handover request includes security information and device information (information including a device address or the like) unique to another mobile phone 1-1. The device information unique to its own mobile phone 1-1 is “BD_ADDR=XXXXXX”. On the other hand, the device information unique to another mobile phone 1-2 is “BD_ADDR=YYYYYY”. In step S507, the NFC communication module 26 of the mobile phone 1-1 receives a response to the handover request from another mobile phone 1-2 during negotiation with another mobile phone 1-2 (step S534 of FIG. 14).

In step S508, the communication mode switching controller 231 of the mobile phone 1-1 acquires the security information and the device information unique to another mobile phone 1-2 from the response to the hangover request received by the NFC communication module 26. The communication mode switching controller 231 of the mobile phone 1-1 provides the pairing controller 233 with the received the security information and the received device information unique to another mobile phone 1-2.

In step S509, the communication mode switching controller 231 notifies the device search controller 232 of the fact that the search for the counterpart device using the NFC communication module 26 has succeeded and the security information and the device information unique to the counterpart device has been received, also notifies the Bluetooth communication module 25 of the handover request (the request for switching the communication mode from the communication mode by the NFC communication module 26 to the communication mode by the Bluetooth communication 25), and switches the communication mode from the NFC communication module 26 to the Bluetooth communication module 25 for the pairing using the Bluetooth communication module 25 (step S535 of FIG. 14).

At this time, when the mobile phone 1-2 as the counterpart device transmits the response (handover response) to the handover request transmitted by using the NFC communication module 26 to the mobile phone 1-1, the mobile phone 1-2 notifies the Bluetooth communication module 25 of the handover request as in the mobile phone 1-1, and switches the communication mode from the NFC communication module 26 to the Bluetooth communication module 25 for the pairing with the mobile phone 1-1 using the Bluetooth communication module 25.

In step S510, when the device search controller 232 receives a notification (a notification indicating that the search for the counterpart device using the NFC communication module 26 has succeeded and the security information and the device information unique to the counterpart device has be received) from the communication mode switching controller 231, the device search process using the Bluetooth communication module 15 executed in the background is stopped.

Thereby, when the handover directed to the Bluetooth communication module 25 is performed by succeeding in the search for the counterpart device using the NFC communication module 26, the normal device search process using the Bluetooth communication module 25 executed in the background substantially simultaneously with the start of the device search process of FIG. 13 is stopped as a useless process.

In step S511, the controller 21 displays a device name (Device A which is a device name of the counterpart device) of the counterpart device on the display device 23 based on the device information unique to the successfully searched counterpart device (another mobile phone 1-2) (step S537 of FIG. 14). FIG. 15C shows a display example of a device name displayed on the counterpart device registration menu screen. As shown in FIG. 156, “Device A” is displayed as the device name of the counterpart device based on the device information unique to the successfully searched counterpart device (another mobile phone 1-2).

In step S512, the controller 21 receives the selection of the counterpart device connected to the mobile phone 1-1 on the new counterpart device registration menu screen by the user operating the user interface 22. In step S513, the pairing controller 233 of the mobile phone 1-1 transmits a connection request to the selected counterpart device (for example, another mobile phone 1-2) by using the Bluetooth communication module 25. Thereafter, the mobile phone 1-2 transmits a connection response to the connection request from the mobile phone 1-1 to the mobile phone 1-1 via the Bluetooth communication module 25.

In step S514, the pairing controller 233 of the mobile phone 1-1 receives the connection response from the selected counterpart device (for example, another mobile phone 1-2) by using the Bluetooth communication module 25. In step S515, the pairing controller 233 of the mobile phone 1-1 performs pairing with another mobile phone by using the Bluetooth communication module 25 based on device information and security information received from another mobile phone 1-2 in step S508 (step S539 of FIG. 14).

Thereafter, the pairing controller 233 of the mobile phone 1-1 performs the authentication process using the Bluetooth communication module 25 and establishes a Bluetooth connection between the mobile phone 1-1 and another mobile phone 1-2 for which the handover request has been permitted.

On the other hand, when the device search controller 232 determines that the search for the counterpart device using the NFC communication module has failed in step S505, the device search controller 232 determines whether or not a given time (for example, a period of 10 sec or the like) has elapsed from the start of the search for the counterpart device using the NFC communication module 26 in step S517.

In the case where the device search controller 232 determines that the given time has not elapsed from the start of the search for the counterpart device using the USC communication module 26 in step S517, the process returns to step S505 and a process subsequent to step S505 is repeatedly executed. Thereby, at least the search for the counterpart device using the NFC communication module 26 is executed until the given time (for example, a period of 10 sec or the like) has elapsed from the start of the search for the counterpart device using the NFC communication module 26.

When the device search controller 232 determines that the given time has elapsed from the start of the search for the counterpart device using the NFC communication module 26 in step S517, the device search controller 232 determines whether or not the device search (the search for the counterpart device) using the Bluetooth communication module 25 executed in the background has succeeded in step S518. When the device search controller 232 determines that the device search (the search for the counterpart device) using the Bluetooth communication module 25 executed in the background has succeeded in step S518, the device search controller 232 acquires security information and device information unique to the counterpart device successfully searched for by using the Bluetooth communication module 25 in step S519.

Thereafter, the process proceeds to step S511, and a device name is displayed in a process subsequent to step S511. A process of pairing with the selected counterpart device is performed.

On the other hand, when the device search counterpart 232 determines that the device search (the search for the counterpart device) using the Bluetooth communication module 25 executed in the background has failed in step S518, the controller 21 displays a search failure message on the display device 23 in step S520. For example, the search failure message is “Device Search Has Failed” or the like.

In terms of the mobile phone according to the third embodiment, a first wireless communication unit (the NFC communication module 26) is used to perform wireless communication between the communication terminal and the counterpart device, and a second wireless communication unit (the Bluetooth communication module 25) is used to perform wireless communication between the communication terminal and the counterpart device. When the first wireless communication unit receives a response to a communication mode switching request for switching the communication mode from the first wireless communication unit to the second wireless communication unit from the counterpart device in the case where the communication terminal and the counterpart device are close to each other in a range where wireless communication by the first wireless communication unit is possible, the communication mode is switched from the first wireless communication unit to the second wireless communication unit based on the communication mode switching request and the second wireless communication unit is controlled so that the search for the counterpart device using the second wireless communication unit is executed in the background when the communication terminal searches for the counterpart device. When the search for the counterpart device using the first wireless communication unit has succeeded, the search for the counterpart device using the second wireless communication unit executed in the background is stopped. When the second wireless communication unit receives a connection response to the connection request after the communication mode is switched from the first wireless communication unit to the second wireless communication unit in the case where the search for the counterpart device using the first wireless communication unit has succeeded, pairing with the counterpart device is controlled using the second wireless communication unit based or device information and security information received from the counterpart device by using the first wireless communication unit.

In terms of the mobile phone according to the third embodiment, it is possible for a communication terminal to prevent a time-consuming operation of acquiring device information or the like regarding a counterpart device in the case of the counterpart device on which a communication unit applicable to the wireless communication mode of NFC is not mounted, and it is possible to efficiently search for a counterpart device regardless of whether or not the counterpart device can switch the communication mode from the first wireless communication unit the NFC communication module 26) to the second wireless communication unit (the Bluetooth communication module 25).

As a result, the mobile phone according to the third embodiment can efficiently search for the counterpart device, and can establish a connection by pairing with the counterpart device seamlessly, even in the case of searching for an existing counterpart device on which a communication unit applicable to the wireless communication mode of NFC is not mounted.

As the second wireless communication unit in place of the Bluetooth communication module 25, a WLAN may be used and another wireless communication means (wireless communication system) may be used.

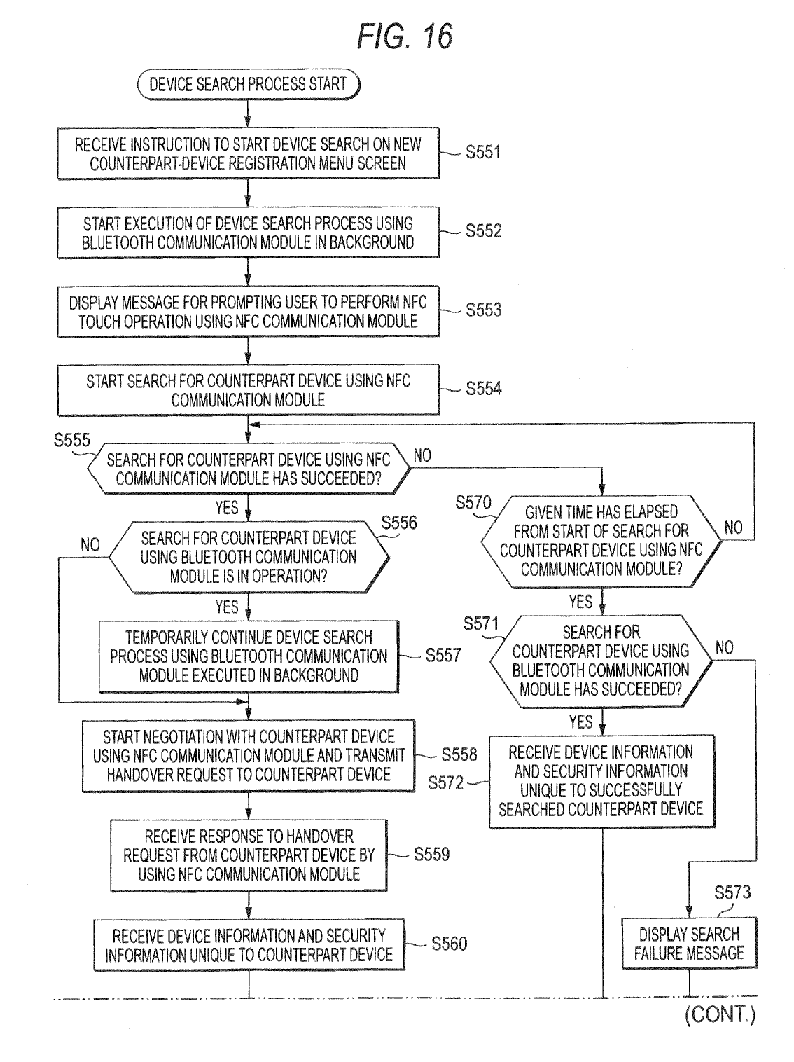

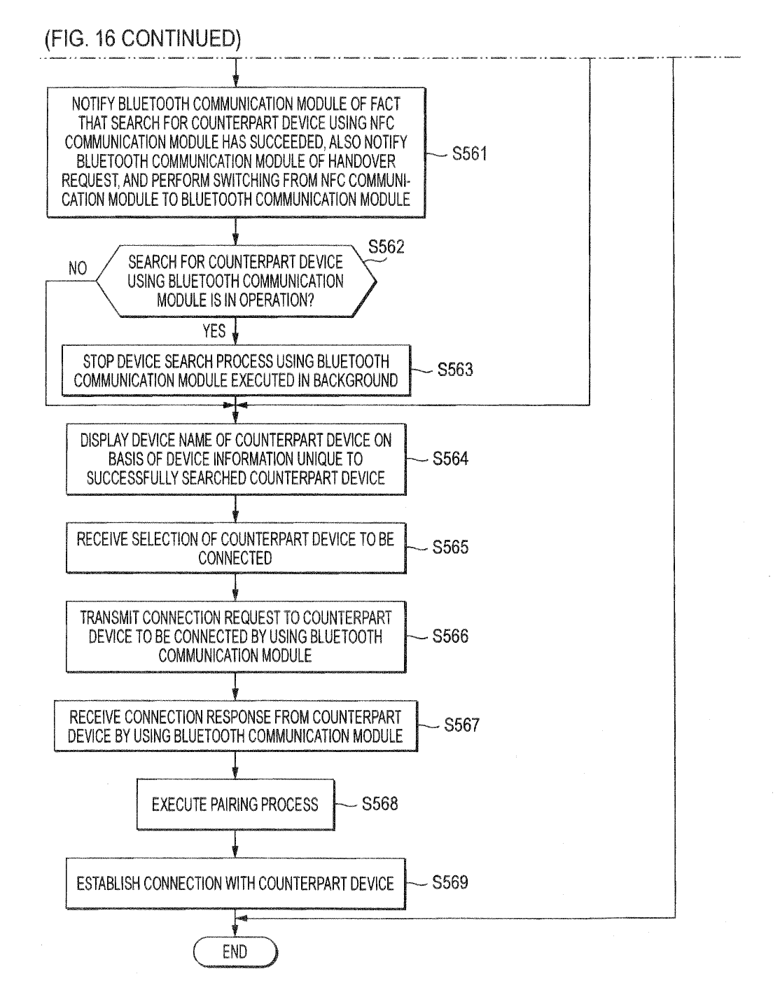

Another device search process in the mobile phone 1-1 of FIG. 12 when the mobile phone 1-1 and the mobile phone 1-2 perform pairing by using the Bluetooth communication module 25 will be described with reference to the flowchart of FIG. 16. Steps S551 to S555, S558 to S561, and S566 to S573 of FIG. 16 are the same as the process of steps S501 to S509 and S511 to S520 of FIG. 13, and thus repeated description thereof is omitted.

When the device search controller 232 determines that the search for the counterpart device using the NFC communication module has succeeded in step S555, the device search controller 232 determines whether or not the search for the counterpart device using the Bluetooth communication module 25 is in operation in step S556.

When the device search controller 232 determines whether or not the search for the counterpart device using the Bluetooth communication module 25 is in operation in step S556, the device search controller 232 controls the Bluetooth communication module 25 to temporarily continue the device search using the Bluetooth communication module 25 executed in the background in step S557.

On the other hand, when the device search controller 232 determines that the search for the counterpart device using the Bluetooth communication module 25 is not in operation in step S556, the process of step S557 is skipped.

Thereafter, after the communication mode is switched from the NFC communication module 26 to the Bluetooth communication module 25 in step S561, the device search controller 232 determines whether or not the search for the counterpart device using the Bluetooth communication module 25 is in operation in step S562.

When the device search controller 232 determines that the search for the counterpart device using the Bluetooth communication module 25 is in operation in step S562, the device search controller 232 controls the Bluetooth communication module 25 to stop the device search process using the Bluetooth communication module 25 executed in the background in step S563. Thereby, when the handover directed to the Bluetooth communication module 25 is made by the success of the search for the counterpart device using the NFC communication module 26, the normal device search process using the Bluetooth communication module 25 executed in the background substantially simultaneously with the start of the device search process of FIG. 16 is stopped as a useless process.

On the other hand, when the device search controller 232 determines that the search for the counterpart device using the Bluetooth communication module 25 is not in operation in step S562, the process of step S563 is skipped.

In terms of the mobile phone according to the third embodiment, it is possible for a communication terminal to prevent a time-consuming operation of acquiring device information or the like regarding a counterpart device in the case of the counterpart device on which a communication unit applicable to the wireless communication mode of NFC is not mounted. Also, it is possible to perform a search for the counterpart device using the NFC communication module 26 while the search for the counterpart device using the Bluetooth communication module it is maintained as much as possible, and it is possible to efficiently search for the counterpart device.

The series of processes described in the third embodiment may be executed by software, but may also be executed by hardware.

In the third embodiment, the steps of the flowchart have been shown as an example of the process to be executed chronologically according to the sequence noted on the flowchart. They also include a process to be executed in parallel or individually as well as the process to be chronologically executed.

Although the embodiments according to the present invention have been described above, the present invention is not limited to the above-mentioned embodiments but can be variously modified. Constituent components disclosed in the aforementioned embodiments may be combined suitably to form various modifications. For example, some of all constituent components disclosed in the embodiments may be removed or may be appropriately combined.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept defined by the appended claims and their equivalents.

What is claimed is:

1. A communication terminal comprising:
a first wireless communication module configured to perform wireless communication with a counterpart device in a first wireless communication mode;
a second wireless communication module configured to perform wireless communication with the counterpart device in a second wireless communication mode;
a communication mode controller configured to control the first wireless communication module to respond to the counterpart device in response to a communication mode switching request and to switch the wireless communication from the first wireless communication mode to the second wireless communication mode, when the communication mode switching request for switching communication mode is received from the counterpart device by the first wireless communication module while the counterpart device is in proximity in a communicable range;
a pairing controller configured to:
accept a connection request received by the second wireless communication module from the counterpart device;
respond to the connection request from the counterpart device using the second wireless communication module; and
control, pairing with the counterpart device using the second wireless communication module based on device information and security information received from the counterpart device using the first wireless communication module; and
an authentication control module configured to:
determine whether or not the counterpart device for which the communication mode switching request is permitted is a registered counterpart device based on a pairing request corresponding to the communication mode switching request notified from the communication mode controller; and
control the pairing controller to discard the pairing request corresponding to the commendation mode switching request notified from the communication mode controller not to perform pairing including an authentication process by the second wireless communication module when determined that the counterpart device for which the communication mode switching request has been permitted is the registered counterpart device.

2. The communication terminal according to claim 1,
wherein the authentication control module is configured to control the pairing controller to perform the pairing including the authentication process by the second wireless communication module without discarding the pairing request corresponding to the communication mode switching request notified from the communication mode controller when determined that the counterpart device for which the communication mode switching request has been permitted is an unregistered counterpart device.

3. The communication terminal according to claim 1,
wherein the pairing controller is configured to perform the authentication process using the second wireless communication module based on pre-stored security information used for the authentication process for establishing a connection with the counterpart device when determined that the counterpart device for which the communication mode switching request is permitted is the registered counterpart device to establish the connection with the counterpart device for which the communication mode switching request is permitted.

4. The communication terminal according to claim 1 further comprising:
an activating module configured to activate at least a part of profiles pre-associated with the counterpart device for which the communication mode switching request is permitted and previously executed in relation to the second wireless communication module before the second wireless communication module receives the connection request from the counterpart device when determined that the counterpart device for which the communication mode switching request is permitted is the registered counterpart device.

5. A communication terminal comprising:
a first wireless communication module configured to perform wireless communication with a counterpart device in a first wireless communication mode;
a second wireless communication module configured to perform wireless communication with the counterpart device in a second wireless communication mode;
a determination module configured to determine whether or not the second wireless communication module is in an available state, when the communication mode switching request for switching communication mode is received from the counterpart device by the first wireless communication module while the counterpart device is in proximity in a communicable range;
a communication mode controller configured to control the first wireless communication module to respond to the counterpart device in response to a communication mode switching request and to switch the wireless communication from the first wireless communication mode to the second wireless communication mode, when the determination module determines that the second wireless communication module is in the available state; and
a pairing controller configured to control pairing with the counterpart device using the second wireless communication module based on device information and security information received from the counterpart device using the first wireless communication module, when the second wireless communication module receives a connection request free the counterpart device.

6. The communication terminal according to claim 5,
wherein, when the determination module determines that the second wireless communication module is not in the available state, the communication mode control responds to the counterpart device in response to the communication mode switching request using the first wireless communication module, changes the second wireless communication module to the available state, and switches the wireless communication from the first wireless communication mode to the second wireless communication mode.

7. A communication terminal comprising:
a first wireless communication module configured to perform wireless communication with a first counterpart device in a first wireless communication mode;
a second wireless communication module configured to perform wireless communication with the first counterpart device in a second wireless communication mode;
a communication mode controller configured to control the first wireless communication module to respond to the first counterpart device in response to a communication mode switching request and to switch the wireless communication from the first wireless communication mode the second wireless communication mode, when the communication movie switching request for switching communication mode is received from the first counterpart device by the first wireless communication module while the first counterpart device is in proximity in a communicable range; and
a pairing controller configured to:
accept a connection request received by the second wireless communication module from the first counterpart device;
respond to the connection request from the first counterpart device using the second wireless communication module; and
control pairing with the first counterpart device using the second wireless communication module based on device information and security information received from the first counterpart device using the first wireless communication module.

8. The communication terminal according to claim 7, wherein, when the second wireless communication module receives a connection request from a second counterpart ice different from the first counterpart device, the pairing controller responds to the second counterpart device to deny the connection request using the second wireless communication module.

9. The communication terminal according to claim 7 further comprising:
a setting module configured to set a reception standby time for waiting the connection request to be received from the first counterpart device using the second wireless communication module,
wherein the communication mode controller is configured to discard the communication mode switching request when the reception standby time set by the setting module is elapsed.

10. The communication terminal according to claim 9,
wherein the communication mode controller is configured to discard the communication mode switching request when a request related to an operation different from a pairing process is accepted by the pairing controller during the reception standby time set by the setting module.

11. A communication terminal comprising:
a first wireless communication module configured to perform wireless communication with a first counterpart device in a first wireless communication mode;
a second wireless communication module configured to perform wireless communication with the first counterpart device in a second wireless communication mode;
a communication mode controller configured to control the first wireless communication module to respond to the first counterpart device in response to a communication mode switching request and to switch the wireless communication from the first wireless communication mode to the second wireless communication mode, when the communication mode switching request for switching communication mode is received from the first counterpart device by the first wireless communication module while the first counterpart device is in proximity in communicable range; and
a pairing controller configured to perform a process when transmitting a connection request to the first counterpart device, the process comprising:
accept a connection request received by the second wireless communication module from the first counterpart device;
respond to the connection request from the first counterpart device using the second wireless communication module; and
control pairing with the first counterpart device using the second wireless communication module based on device information and security information received from the first counterpart device using the first wireless communication module.

12. The communication terminal according to claim 11,
wherein, when the second wireless communication module receives a connection request from a second counterpart device different from the first counterpart device, the pairing controller responds to the second counterpart device to deny the connection request using the second wireless communication module.

13. The communication terminal according to claim 11 further comprising:
a resting module configured to set a transmission time for completing transmission of the connection request to the first counterpart device using the second wireless communication module,
wherein the pairing controller is configured to accept the connection request received by the second wireless communication module from the first counterpart device during the transmission time set by the setting module and before completing the transmission of the connection request to the first counterpart device using the second wireless communication module.

14. The communication terminal according to claim 13,
wherein the communication mode controller is configured to discard the communication mode switching request when the transmission time set by the setting module is elapsed.

15. The communication terminal according to claim 13,
wherein the communication mode controller is configured to discard the communication mode switching request when a request related to an operation different from a pairing process is accepted by the pairing controller during the transmission time set by the setting module.

16. The communication terminal according to claim 11,
wherein, when the second wireless communication module receives the connection request from the first counterpart device before completing the transmission of the connection request to the first counterpart device using the second wireless communication module, the pairing controller discards a connection request to be transmitted by the communication terminal to the first counterpart device.

17. A communication terminal comprising:
a first wireless communication module configured to perform wireless communication with a counterpart device in a first wireless communication mode;
a second wireless communication module configured to perform wireless communication with the counterpart device in second wireless communication mode;
a communication mode controller configured to control the first wireless communication module to respond to the counterpart device in response to a communication mode switching request and to switch the wireless communication from the first wireless communication mode to the second wireless communication mode, when the communication mode switching request for switching communication mode is received from the counterpart device by the first wireless communication module while the counterpart device is in proximity in a communicable range;
a device search controller configured to:
control the second wireless communication module so that the execution of a search for a counterpart device is started in a background using the second wireless communication module when the communication terminal searches for the counterpart device; and
stop the search for the counterpart device using the second wireless communication module executed in the background when the search for the counterpart device using the first wireless communication module is completed; and
a pairing controller configured to control pairing with the counterpart device using the second wireless communication module based on device information and security information received from the counterpart device using the first wireless communication module when the second wireless communication module receives a connection response to a connection request after the communication mode controller switches the communication mode from the first wireless communication mode to the second wireless communication mode in a case where the device search controller is succeeded in the search for the counterpart device using the first wireless communication module.

18. The communication terminal according to claim 17,
wherein, when a given time is elapsed from the start of the search for the counterpart device using the first wireless communication module in a state in which the device search controller failed to succeed in the search for the counterpart device using the first wireless communication module, the pairing controller controls the pairing with the counterpart device using the second wireless communication module based on device information and security information received from the counterpart device using the second wireless communication module.

19. The communication terminal according to claim 17 further comprising:
a display module configured to display a result of the search for the counterpart device using the second wireless communication module by the device search controller when a given time is elapsed from the start of the search for she counterpart device using the first wireless communication module in a state in which the device search controller failed to succeed in the search for the counterpart device using the first wireless communication module.

20. The communication terminal according to claim 17 further comprising:
a display module configured to display a result of the search for the counterpart device using the first wireless communication module by the device search controller when the device search controller is succeeded in the search for the counterpart device using the first wireless communication module.

21. A communication terminal comprising:
a first wireless communication module configured to perform wireless communication with a counterpart device in a first wireless communication mode;
a second wireless communication module configured to perform wireless communication with the counterpart device in a second wireless communication mode;
a communication mode controller configured to control the first wireless communication module to respond to the counterpart device in response to a communication mode switching request and to switch the wireless communication from the first wireless communication mode to the second wireless communication mode, when the communication mode switching request for switching communication mode is received from the counterpart device by the first wireless communication module while the counterpart device is in proximity in a communicable range;
a device search controller configured to:
control the second wireless communication module so that the execution of a search for a counterpart device is started in a background using the second wireless communication module when the communication terminal searches for the counterpart device;
continue the search for the counterpart device using the second wireless communication module when the search for the counterpart device using the second wireless communication module is in execution in a case where the search for the counterpart device using the first wireless communication module has succeeded; and
stop the search for the counterpart device using the second wireless communication module when the search for the counterpart device using the second wireless communication module is in execution in a case where the communication mode controller switches the communication mode from the first wireless communication module to the second wireless communication module; and
a pairing controller configured to control pairing with the counterpart device using the second wireless communication module based on device information and security information received from the counterpart device using the first wireless communication module when the second wireless communication module receives a connection response to a connection request after the communication mode controller switches the communication mode from the first wireless communication module to the second wireless communication module in a case where the device search controller has succeeded in the search for the counterpart device using the first wireless communication module.

22. The communication terminal according to claim 21,
wherein, when a given time is elapsed from the start of the search for the counterpart device using the first wireless communication module in a state in which the device search controller failed to succeed in the search for the counterpart device using the first wireless communication module, the pairing controller controls the pairing with the counterpart device using the second wireless communication module based on device information and security information received from the counterpart device using the second wireless communication module.

23. The communication terminal according to claim 21 further comprising:
a display module configured to display a result of the search for the counterpart device using the second wireless communication module by the device search controller when a given time is elapsed from the start of the search for the counterpart device using the first wireless communication module in a state in which the device search controller failed to succeed in the search for the counterpart device using the first wireless communication module.

24. The communication terminal according to claim 21 further comprising:
a display module configured to display a result of the search for the counterpart device using the first wireless communication module by the device search controller when the device search controller is succeeded in the search for the counterpart device using the first wireless communication module.
